(19) United States
(12) Patent Application Publication
(10) Pub. No.: US 2024/0337542 A1
(43) Pub. Date: Oct. 10, 2024

(54) LOAD DETECTION DEVICE

(71) Applicant: Panasonic Intellectual Property Management Co., Ltd., Osaka (JP)

(72) Inventors: Mitsutaka YAMAGUCHI, Gifu (JP); Yuta YAMAMOTO, Kyoto (JP); Hironobu UKITSU, Osaka (JP); Yuta MORIURA, Osaka (JP); Takafumi HAMANO, Fukuoka (JP); Hiroyuki FURUYA, Osaka (JP)

(21) Appl. No.: 18/749,053

(22) Filed: Jun. 20, 2024

Related U.S. Application Data
(63) Continuation of application No. PCT/JP2022/039386, filed on Oct. 21, 2022.

(30) Foreign Application Priority Data
Dec. 24, 2021 (JP) 2021-211272

(51) Int. Cl. G01L 1/14

(52) U.S. Cl. CPC G01L 1/144

(57) ABSTRACT

A load detection device includes: a load sensor including at least one first electrode, at least one second electrode disposed so as to cross the first electrode, and a dielectric body present between the first electrode and the second electrode; a detection circuit configured to detect change in a voltage in a crossing position between the first electrode and the second electrode; a connector configured to connect the first electrode and the second electrode to the detection circuit; and a control circuit configured to control the detection circuit, and configured to detect a load applied at the crossing position, based on change in a voltage detected by the detection circuit. The control circuit executes control of detecting a combination of, out of the plurality of terminals of the connector, the terminals to which the first electrode and the second electrode are respectively connected.

### CROSS REFERENCE TO RELATED APPLICATION

This application is a continuation of International Application No. PCT/JP2022/039386 filed on Oct. 21, 2022, entitled “LOAD DETECTION DEVICE”, which claims priority under 35 U.S.C. Section 119 of Japanese Patent Application No. 2021-211272 filed on Dec. 24, 2021, entitled “LOAD DETECTION DEVICE”. The disclosures of the above applications are incorporated herein by reference.

### BACKGROUND OF THE INVENTION

### Field of the Invention

The present invention relates to a load detection device that detects a load, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

Japanese Laid-Open Patent Publication No. 2021-81341 describes a load detection device including: a capacitance-type load sensor including a plurality of first electrodes disposed so as to be arranged in one direction, a second electrode disposed so as to cross the plurality of first electrodes, and a dielectric body present between the first electrode and the second electrode; and a detection circuit for detecting change in the capacitance at a crossing position between the first electrode and the second electrode. In this load detection device, a constant voltage is applied via a resistor to the crossing position between the first electrode and the second electrode. Based on change in the voltage in a stage following the resistor after the application of the constant voltage, the capacitance at each crossing position is detected.

In the load detection device having the above configuration, a circuitry for detecting the load is designed so as to correspond to a load sensor serving as the connection target. However, the numbers of the first electrodes and the second electrodes disposed in the load sensor, that is, the number of element parts defined at the crossing positions between these electrodes can be changed as appropriate in accordance with the use purpose of the load sensor. Therefore, in the load detection device, the configuration of the circuitry needs to be changed for each type of the load sensor.

### SUMMARY OF THE INVENTION

A load detection device according to a main aspect of the present invention includes: a load sensor including at least one first electrode, at least one second electrode disposed so as to cross the first electrode, and a dielectric body present between the first electrode and the second electrode; a detection circuit configured to detect change in a voltage in a crossing position between the first electrode and the second electrode; a connector configured to connect the first electrode and the second electrode to the detection circuit; and a control circuit configured to control the detection circuit, and configured to detect a load applied at the crossing position, based on change in a voltage detected by the detection circuit. The connector includes a plurality of terminals in a number that can cope with a plurality of types of the load sensors between which numbers of the first electrode and the second electrode are different from each other. The control circuit executes control of detecting a combination of, out of the plurality of terminals, the terminals to which the first electrode and the second electrode are respectively connected.

According to the load detection device of the present aspect, the connector includes the terminals in numbers that can cope with a plurality of types of the load sensor between which the numbers of the first electrode and the second electrode are different from each other. Therefore, even when the type of the load sensor to be used is changed, it is possible to cope with the load sensor 1 by the same connector. In addition, the control circuit detects a combination of the terminals, out of the plurality of terminals, to which the first electrode and the second electrode are respectively connected. Therefore, whichever type of the load sensor is connected to the connector, load detection can be smoothly performed by the same circuitry.

The effects and the significance of the present invention will be further clarified by the description of the embodiments below. However, the embodiment below is merely an example for implementing the present invention. The present invention is not limited to the description of the embodiment below in any way.

### BRIEF DESCRIPTION OF THE DRAWINGS

FIG. 1A is a perspective view schematically showing a base member and electrically-conductive elastic bodies set on the upper face of the base member according to an embodiment;

FIG. 1B is a perspective view schematically showing a state where conductor wires are set on the structure in FIG. 1A according to the embodiment;

FIG. 2A is a perspective view schematically showing a state where threads are set on the structure in FIG. 1B according to the embodiment;

FIG. 2B is a perspective view schematically showing a state where a base member is set on the structure in FIG. 2A;

FIG. 3A and FIG. 3B each schematically show a cross section of a load sensor according to the embodiment;

FIG. 4 is a plan view schematically showing a configuration of the inside of the load sensor according to the embodiment;

FIG. 5 is a circuit diagram showing a configuration of a detection circuit according to the embodiment, and in FIG. 5, a load sensor in which element parts are arranged in a matrix shape of 3 rows and 3 columns is connected to the connector;

FIG. 6 is a circuit diagram showing a configuration of the detection circuit according to the embodiment, and in FIG. 6, a load sensor in which element parts are arranged in a matrix shape of 4 rows and 4 columns is connected to the connector;

FIG. 7 is a circuit diagram showing a configuration of the detection circuit according to the embodiment, and in FIG. 7, a load sensor in which element parts are arranged in a matrix shape of 5 rows and 5 columns is connected to the connector;

FIG. 8 is a circuit diagram showing a configuration of the detection circuit according to the embodiment, and in FIG. 8, a load sensor in which element parts are arranged in a matrix shape of 6 rows and 6 columns is connected to the connector;

FIG. 9 is a block diagram showing a configuration of a load detection device according to the embodiment, and in FIG. 9, an operation terminal is connected to the load detection device to form a load detection system;

FIG. 10A and FIG. 10B each show an interface screen displayed on the operation terminal according to the embodiment;

FIG. 11 is a flowchart showing a process executed upon supply of power to the load detection device according to the embodiment;

FIG. 12A is a flowchart showing an initialization process according to the embodiment;

FIG. 12B is a flowchart showing a detection process of the type of the load sensor according to the embodiment;

FIG. 13 shows a set state of rows and columns with respect to the terminals of the connector according to the embodiment;

FIG. 14 schematically shows voltages that respectively occur in a voltage measurement terminal when there is an element part and when there is no element part at a crossing position between a row and a column having been selected, according to the embodiment;

FIG. 15 is a circuit diagram showing a configuration of the detection circuit according to Modification 1, and in FIG. 15, a load sensor in which element parts are arranged in a matrix shape of 5 rows and 5 columns is connected to the connector;

FIG. 16 schematically shows voltages that respectively occur in the voltage measurement terminal when there is an element part and when there is no element part at a crossing position of a row and a column having been selected, according to Modification 1;

FIG. 17 is a flowchart showing the detection process of the type of the load sensor according to Modification 1;

FIG. 18 shows an interface screen displayed on the operation terminal according to Modification 1;

FIG. 19 is a circuit diagram showing a configuration of the detection circuit according to Modification 2, and in FIG. 19, a load sensor in which element parts are arranged in a matrix shape of 5 rows and 5 columns is connected to the connector;

FIG. 20A is a flowchart showing the detection process of the type of the load sensor according to Modification 2; and

FIG. 20B is a flowchart showing a process of detecting a defect in an element part according to Modification 2.

It is noted that the drawings are solely for description and do not limit the scope of the present invention in any way.

### DETAILED DESCRIPTION

A load detection device according to the present invention is applicable to a management system or the like that performs processing in accordance with an applied load. Examples of the management system include a stock management system, a driver monitoring system, a coaching management system, a security management system, and a caregiving/nursing management system.

In the stock management system, for example, by a load sensor provided to a stock shelf, the load of a placed commodity is detected, and the kinds of commodities and the number of commodities present on the stock shelf are detected. Accordingly, in a store, a factory, a warehouse, and the like, the commodities can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detection device of the embodiment below is applied to a management system as described above, for example. The load detection device of the embodiment below includes: a load sensor for detecting a load; a detection circuit combined with the load sensor, and a control circuit that controls the detection circuit. The load sensor of the embodiment below is a capacitance-type load sensor. Such a load sensor may be referred to as a “capacitance-type pressure-sensitive sensor element”, a “capacitive pressure detection sensor element”, a “pressure-sensitive switch element”, or the like. The embodiment below is an example of embodiments of the present invention, and the present invention is not limited to the embodiment below in any way.

Hereinafter, an embodiment of the present invention will be described with reference to the drawings. For convenience, X-, Y-, and Z-axes orthogonal to each other are indicated in the drawings. The Z-axis direction is the height direction of a load sensor 1.

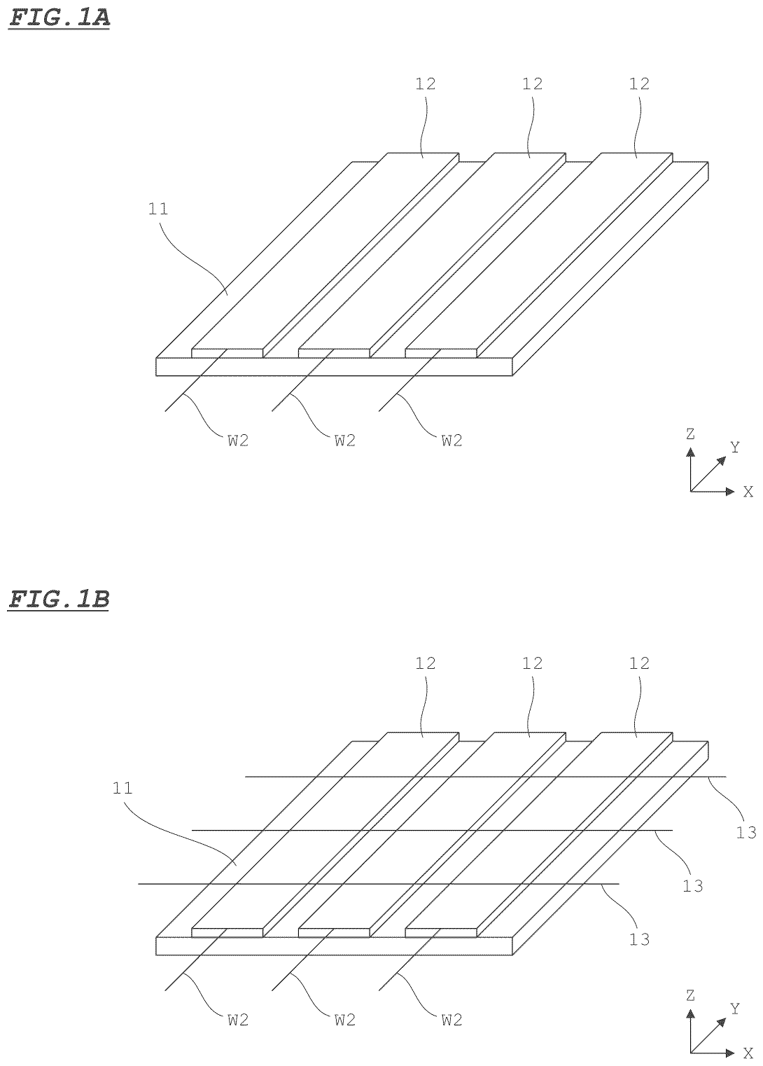

With reference to FIG. 1A to FIG. 4, the load sensor 1 will be described.

FIG. 1A is a perspective view schematically showing a base member 11 and electrically-conductive elastic bodies 12 set on the upper face (the face on the Z-axis positive side) of the base member 11.

The base member 11 is an insulative flat-plate-shaped member having elasticity. The base member 11 has a rectangular shape in a plan view. The thickness of the base member 11 is constant. The thickness of the base member 11 is 0.01 mm to 2 mm, for example. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face (the face on the Z-axis positive side) of the base member 11. In FIG. 1A, three electrically-conductive elastic bodies 12 are disposed on the upper face of the base member 11. The electrically-conductive elastic bodies 12 are each an electrically-conductive member having elasticity. Each electrically-conductive elastic body 12 has a band-like shape that is long in the Y-axis direction. The three electrically-conductive elastic bodies 12 are disposed so as to be arranged with a predetermined interval therebetween in the X-axis direction. At an end portion on the Y-axis negative side of each electrically-conductive elastic body 12, a wiring cable W2 electrically connected to the electrically-conductive elastic body 12 is set.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example.

Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 are set on the structure in FIG. 1A.

Each conductor wire 13 has a linear shape, and is disposed so as to be superposed on the upper faces of the electrically-conductive elastic bodies 12 shown in FIG. 1A. In the present embodiment, three conductor wires 13 are disposed so as to be superposed on the upper faces of the three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12.

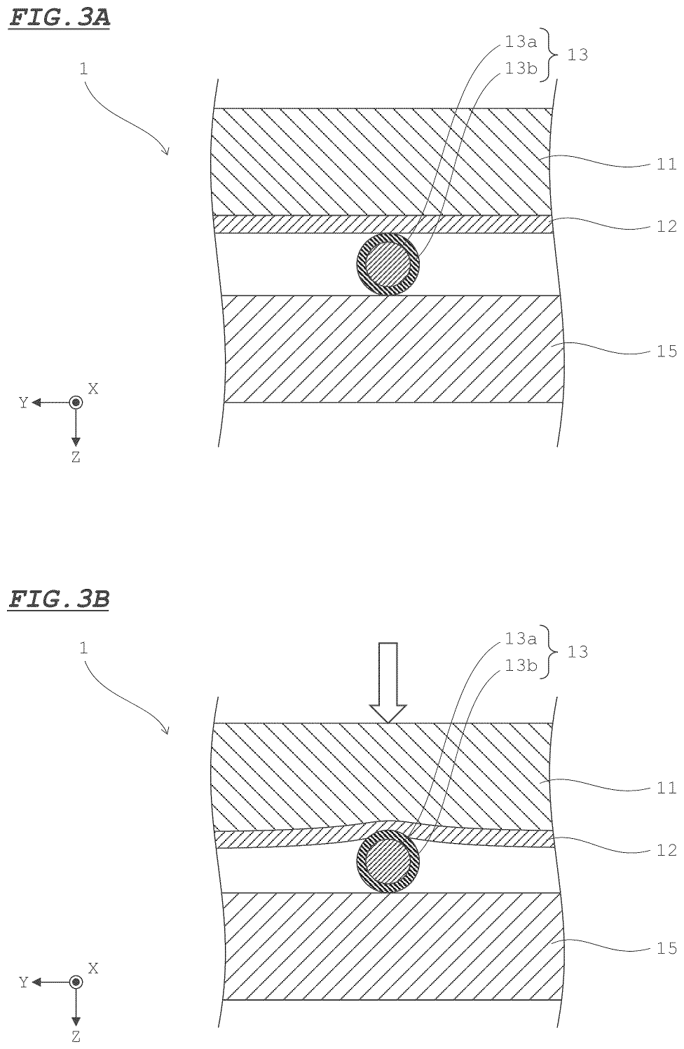

The conductor wire 13 is a covered copper wire, for example. The conductor wire 13 is composed of an electrically-conductive member having a linear shape, and a dielectric body formed on the surface of the electrically-conductive member. The configuration of the conductor wire 13 will be described later with reference to FIGS. 3A, 3B.

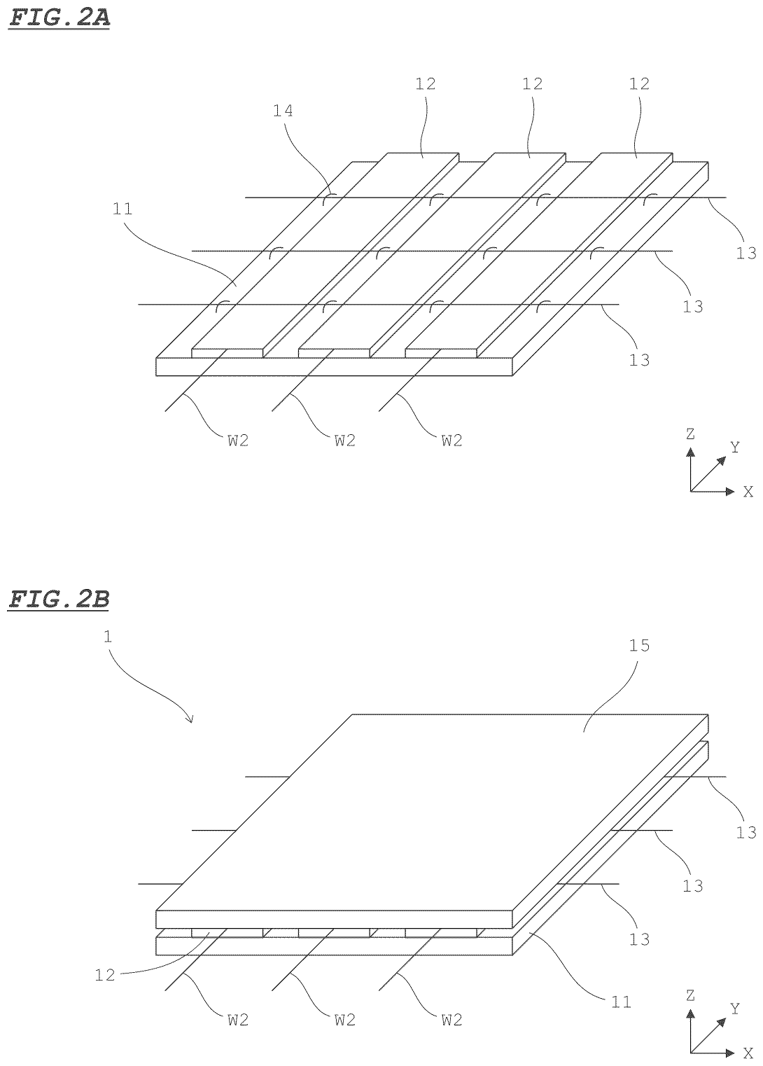

FIG. 2A is a perspective view schematically showing a state where threads 14 are set on the structure in FIG. 1B.

After the conductor wires 13 are disposed as shown in FIG. 1B, each conductor wire 13 is connected to the base member 11 by threads 14 so as to be able to move in the longitudinal direction (the X-axis direction) of the conductor wire 13. In the example shown in FIG. 2A, twelve threads 14 connect the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a base member 15 is set on the structure in FIG. 2A.

The base member 15 is set from above (the Z-axis positive side) the structure shown in FIG. 2A. The base member 15 is an insulative member. The base member 15 is a resin material of at least one type selected from the group consisting of polyethylene terephthalate, polycarbonate, polyimide, and the like, for example. The base member 15 may be formed from the same material as that of the base member 11. The base member 15 has a flat plate shape parallel to an X-Y plane, and has the same size and shape as those of the base member 11 in a plan view. The thickness in the Z-axis direction of the base member 15 is 0.01 mm to 2 mm, for example.

The outer peripheral four sides of the base member 15 are connected to the outer peripheral four sides of the base member 11 with a silicone rubber-based adhesive, a thread, or the like. Accordingly, the base member 15 is fixed to the base member 11. The conductor wires 13 are sandwiched by the electrically-conductive elastic bodies 12 and the base member 15. Accordingly, the load sensor 1 is completed as shown in FIG. 2B. The load sensor 1 can be used with its front face and back face reversed from the state in FIG. 2B.

FIG. 3A and FIG. 3B each schematically show a cross section of the load sensor 1 along a plane parallel to a Y-Z plane at the center position in the X-axis direction of the electrically-conductive elastic body 12. FIG. 3A shows a state where no load is applied, and FIG. 3B shows a state where a load is applied.

As shown in FIGS. 3A, 3B, the conductor wire 13 is composed of an electrically-conductive member 13a and a dielectric body 13b formed on the electrically-conductive member 13a. The electrically-conductive member 13a is a member that is electrically conductive and that has a linear shape. The dielectric body 13b covers the surface of the electrically-conductive member 13a. The electrically-conductive member 13a is formed from copper, for example. The diameter of the electrically-conductive member 13a is about 60 μm, for example.

The dielectric body 13b has an electric insulation property, and is formed from a resin material, a ceramic material, a metal oxide material, or the like, for example. The dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 13b may be a metal oxide material of at least one type selected from the group consisting of Al₂O₃, Ta₂O₅, and the like.

As shown in FIG. 3A, when no load is applied, the force applied between the electrically-conductive elastic body 12 and the conductor wire 13, and the force applied between the base member 15 and the conductor wire 13 are substantially zero. From this state, as shown in FIG. 3B, when a load is applied to the face on the Z-axis negative side of the base member 11, the electrically-conductive elastic body 12 and the base member 11 are deformed by the conductor wire 13.

As shown in FIG. 3B, due to the application of a load, the conductor wire 13 is brought close to the electrically-conductive elastic body 12 so as to be wrapped by the electrically-conductive elastic body 12. In association with this, the contact area between the conductor wire 13 and the electrically-conductive elastic body 12 increases. Accordingly, the capacitance between the electrically-conductive member 13a and the electrically-conductive elastic body 12 changes. The capacitance between the electrically-conductive member 13a and the electrically-conductive elastic body 12 is detected, whereby the load applied to this region is acquired.

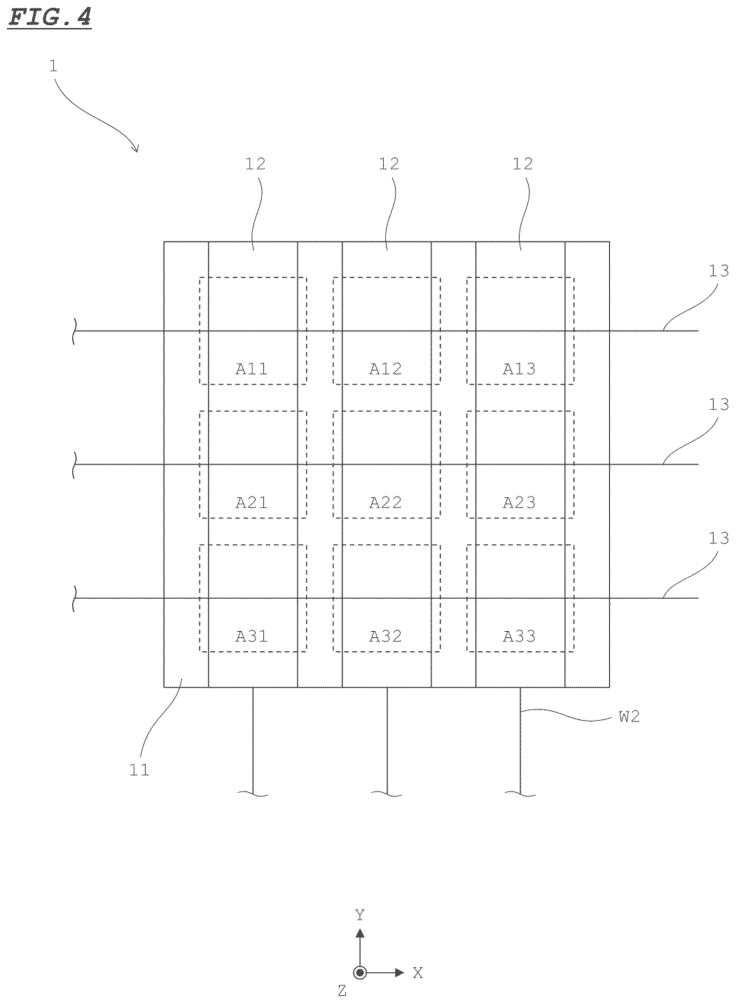

FIG. 4 is a plan view schematically showing a configuration of the inside of the load sensor 1. In FIG. 4, the threads 14 and the base member 15 are not shown for convenience.

As shown in FIG. 4, element parts A11, A12, A13, A21, A22, A23, A31, A32, A33 in which the capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 1 (capacitance-type load sensor), the electrically-conductive elastic body 12 forms the other electrode of the load sensor 1 (capacitance-type load sensor), and the dielectric body 13b (see FIGS. 3A, 3B) included in the conductor wire 13 corresponds to a dielectric body that defines the capacitance in the load sensor 1 (capacitance-type load sensor).

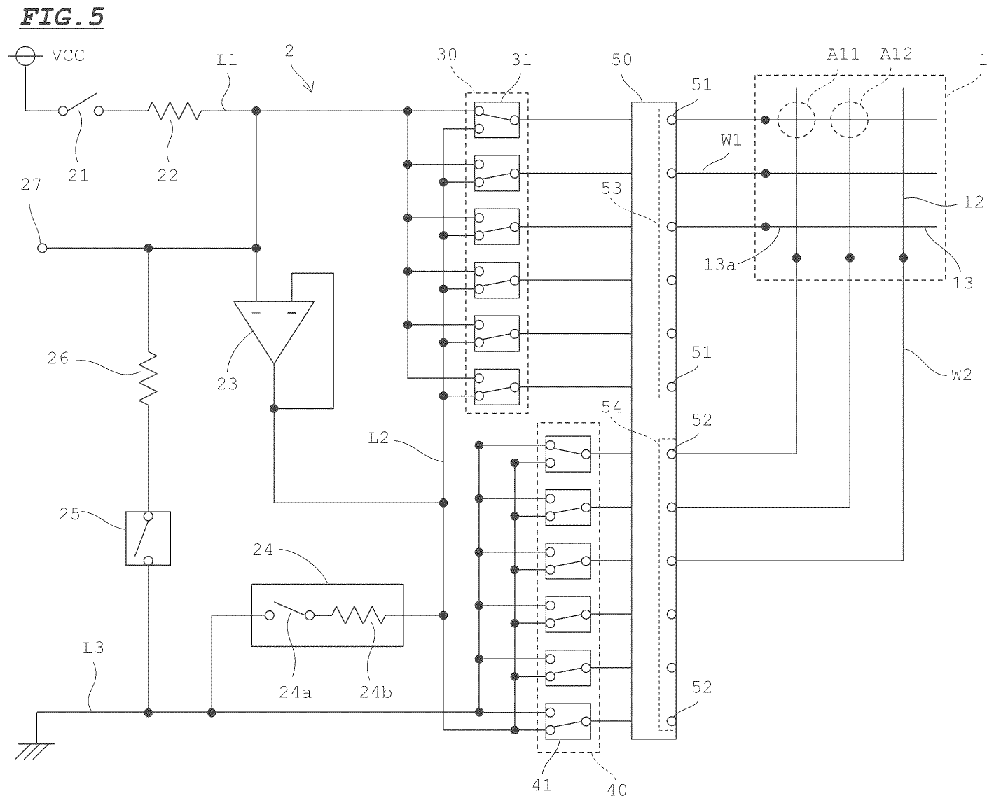

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion on the X-axis negative side of each conductor wire 13 and an end portion on the Y-axis negative side of the wiring cable W2 set to each electrically-conductive elastic body 12 are connected to a detection circuit 2 described later with reference to FIG. 5.

When a load is applied to the element part A11, the contact area between the electrically-conductive member 13a of the conductor wire 13 and the electrically-conductive elastic body 12 increases via the dielectric body 13b in the element part A11. In this case, when the capacitance between the electrically-conductive elastic body 12 on the most X-axis negative side and the conductor wire 13 on the most Y-axis positive side is detected, the load applied to the element part A11 can be calculated. Similarly, in another element part as well, when the capacitance between the electrically-conductive elastic body 12 and the conductor wire 13 crossing each other in the other element part is detected, the load applied to the other element part can be calculated.

FIG. 5 is a circuit diagram showing a configuration of the detection circuit 2 which detects the capacitance in each element part. In FIG. 5, for convenience, as the configuration of the load sensor 1, only the conductor wires 13 and the electrically-conductive elastic bodies 12 are shown, and the electrically-conductive elastic bodies 12 are each shown in a linear shape.

The detection circuit 2 includes a switch 21, a resistor 22, an equipotential generation part 23, switches 24, 25, a resistor 26, a voltage measurement terminal 27, a first switchover part 30, a second switchover part 40, and a connector 50. The detection circuit 2 is a circuit for detecting change in the capacitance at each crossing position between a conductor wire 13 and an electrically-conductive elastic body 12 with respect to the load sensor 1.

One terminal of the switch 21 is connected to a VCC power supply line of a circuit board 5 described later, and the other terminal of the switch 21 is connected to the resistor 22. The resistor 22 is disposed between the switch 21 and a plurality of the conductor wires 13. A first supply line L1 is connected to the downstream-side terminal of the resistor 22.

The first supply line L1 is connected to the first switchover part 30, the equipotential generation part 23, the resistor 26, and the voltage measurement terminal 27. The output-side terminal of the equipotential generation part 23 is connected to a second supply line L2. The equipotential generation part 23 is an operational amplifier, and the output-side terminal and the input-side negative terminal are connected to each other. The equipotential generation part 23 generates a suppression voltage that is equipotential to the potential (the potential on the downstream side of the resistor 22) of the first supply line L1.

The second supply line L2 is connected to the equipotential generation part 23, the first switchover part 30, and the second switchover part 40. The switch 24 is an electric element including a resistor component interposed between the second supply line L2 and a ground line L3. In FIG. 5, for convenience, the switching function of the switch 24 is shown as a switch part 24a, and the resistor component of the switch 24 is shown as a resistor part 24b. When the switch part 24a is set to an ON-state, the second supply line L2 is connected to the ground line L3 via the resistor part 24b.

The switch 25 is interposed between the first supply line L1 and the ground line L3. When the switch 25 is set to an ON-state, the first supply line L1 is connected to the ground line L3 via the resistor 26. The voltage measurement terminal 27 is connected to a control circuit 3 described later.

The first switchover part 30 selectively connects either one of the first supply line L1 for supplying the potential on the downstream side of the resistor 22 and the second supply line L2 for supplying the suppression voltage, to a plurality of first terminals 51 of the connector 50.

Specifically, the first switchover part 30 includes six multiplexers 31. The output-side terminals of the six multiplexers 31 are respectively connected, in a one-to-one relationship, to six first terminals 51 on the upper side of the connector 50. Each multiplexer 31 is provided with two input-side terminals. The first supply line L1 is connected to one input-side terminal, and to this input-side terminal, a voltage is applied from the VCC power supply line via the resistor 22 and the first supply line L1. The other input-side terminal of the multiplexer 31 is connected to the second supply line L2, and to this input-side terminal, the suppression voltage is applied from the equipotential generation part 23 via the second supply line L2.

The second switchover part 40 selectively connects either one of the second supply line L2 for supplying the suppression voltage and the ground line L3 set to be equipotential to the ground, to a plurality of second terminals 52 of the connector 50.

Specifically, the second switchover part 40 includes six multiplexers 41. The output-side terminals of the six multiplexers 41 are respectively connected, in a one-to-one relationship, to six second terminals 52 on the lower side of the connector 50. Each multiplexer 41 is provided with two input-side terminals. The second supply line L2 is connected to one input-side terminal, and to this input-side terminal, the suppression voltage is applied from the equipotential generation part 23 via the second supply line L2. The other input-side terminal of the multiplexer 41 is connected to the ground line L3.

Switching of the switch 21, the switch part 24a, the switch 25, and the multiplexers 31, 41 is controlled by the control circuit 3 as described later.

The connector 50 is configured so as to be able to connect a plurality of types of the load sensors 1 between which the numbers of the electrically-conductive elastic bodies 12 and the conductor wires 13 (the electrically-conductive members 13a) are different from each other. That is, the connector 50 includes a plurality of the first terminals 51 and a plurality of the second terminals 52 in numbers that allow, with respect to a plurality of types of the load sensors 1, connection of the wiring cables W1 drawn from the conductor wires 13 (the electrically-conductive members 13a) and the wiring cables W2 drawn from the electrically-conductive elastic bodies 12. Here, the connector 50 has six first terminals 51 and six second terminals 52.

The connector 50 is provided with a first connection part 53 for connecting the wiring cables W1 to the six first terminals 51 and a second connection part 54 for connecting the wiring cables W2 to the six second terminals 52. For example, in the first connection part 53 and the second connection part 54, the electrodes at the end portions of the wiring cables W1, W2 are pressure-welded to the first terminals 51 and the second terminals 52, whereby the wiring cables W1, W2 are connected to corresponding first terminals 51 and the second terminals 52.

In the example in FIG. 5, a 3×3 load sensor 1 that has three electrically-conductive elastic bodies 12 and three conductor wires 13 (the electrically-conductive members 13a) is connected to the connector 50. Therefore, three wiring cables W1 drawn from the load sensor 1 are respectively connected to three first terminals 51 out of the six first terminals 51 on the upper side, and three wiring cables W2 drawn from the load sensor 1 are respectively connected to three second terminals 52 out of the six second terminals 52 on the lower side.

The three wiring cables W1 are integrated with a flexible printed wiring board, for example, and an end portion of this flexible printed wiring board is mounted to the first connection part 53, whereby the electrodes at the end portions of the three wiring cables W1 are respectively connected to the three first terminals 51 on the connector 50 side. Similarly, the three wiring cables W2 are integrated with a flexible printed wiring board, for example, and an end portion of this flexible printed wiring board is mounted to the second connection part 54, whereby the electrodes at the end portions of the three wiring cables W2 are respectively connected to the three second terminals 52 on the connector 50 side.

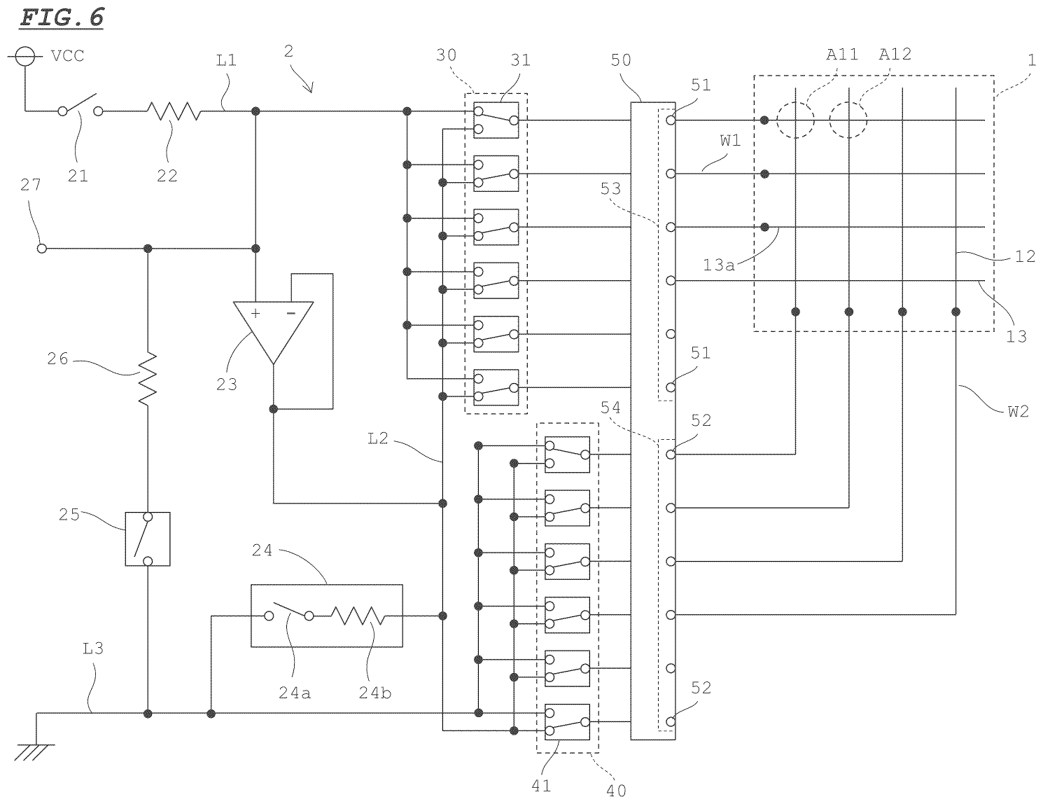

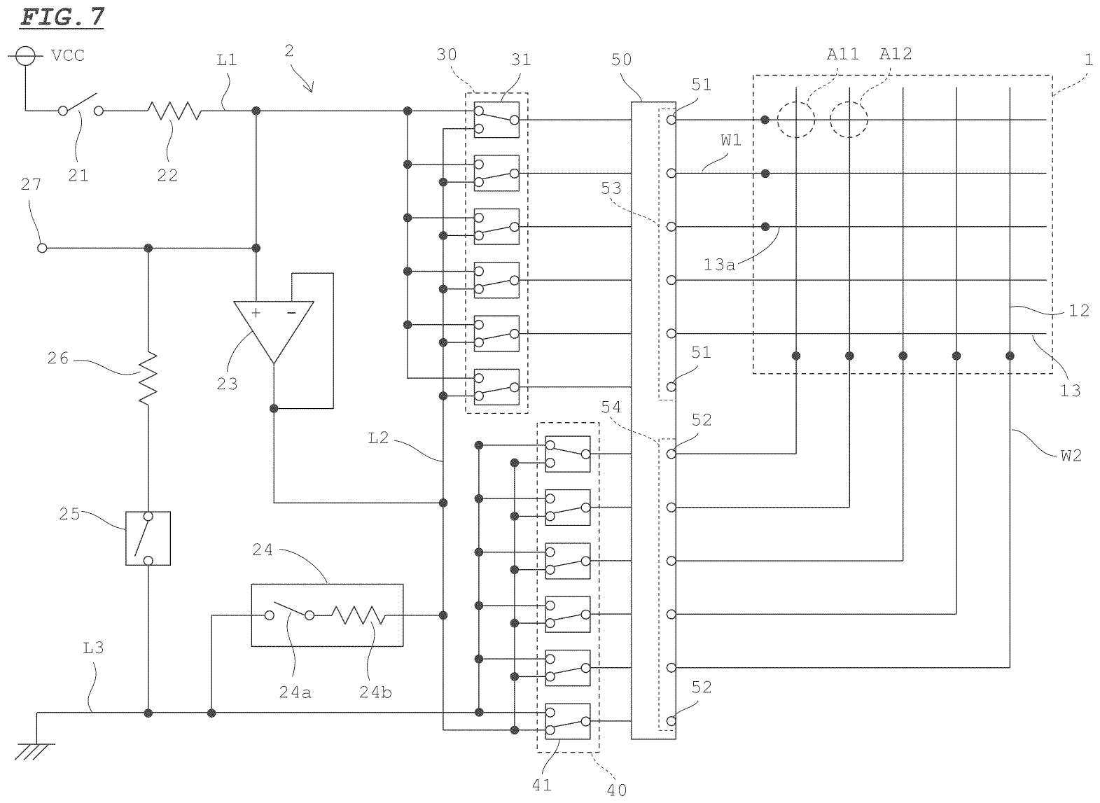

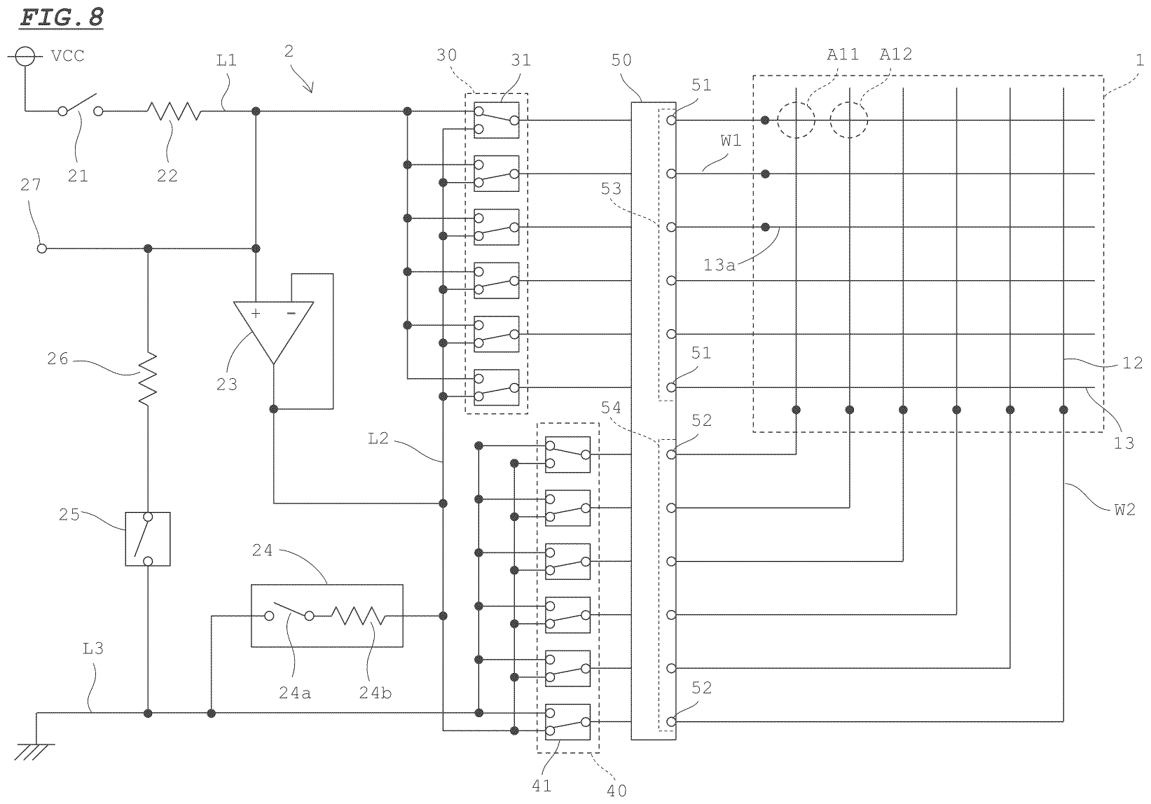

A 4×4 load sensor 1 that has four electrically-conductive elastic bodies 12 and four conductor wires 13 (the electrically-conductive members 13a) is connected to the connector 50, as shown in FIG. 6. A 5×5 load sensor 1 that has five electrically-conductive elastic bodies 12 and five conductor wires 13 (the electrically-conductive members 13a) is connected to the connector 50, as shown in FIG. 7. A 6×6 load sensor 1 that has six electrically-conductive elastic bodies 12 and six conductor wires 13 (the electrically-conductive members 13a) is connected to the connector 50, as shown in FIG. 8. Thus, a plurality of types of the load sensors 1 between which the numbers of the electrically-conductive elastic bodies 12 and the conductor wires 13 (the electrically-conductive members 13a) are different from each other can be connected to the connector 50.

In the load sensor 1 that is connected, the number of the electrically-conductive elastic bodies 12 and the number of the conductor wires 13 (the electrically-conductive members 13a) need not necessarily be the same with each other. For example, a load sensor 1 that has three electrically-conductive elastic bodies 12 and five conductor wires 13 (the electrically-conductive members 13a) may be connected to the connector 50.

Next, control of the detection circuit 2 during load detection will be described.

For example, in the configuration in FIG. 5, when the load on the element part A11 is to be detected, the six multiplexers 31 included in the first switchover part 30 and the six multiplexers 41 included in the second switchover part 40 are set to be in the state in FIG. 5. That is, the uppermost multiplexer 31 connected to the conductor wire 13 (the electrically-conductive member 13a) forming one electrode of the element part A11 is connected to the first supply line L1, and the uppermost multiplexer 41 connected to the electrically-conductive elastic body 12 forming the other electrode of the element part A11 is connected to the ground line L3. The switches 21, 24, 25 are set to an open state as in FIG. 5.

From this state, the switch 21 is closed only for a certain period. Accordingly, a voltage VCC is applied to the element part A11, and in accordance with electricity being stored in the element part A11, the voltage of the voltage measurement terminal 27 increases according to the time constant defined by the capacitance in the element part A11 and the resistor 22. The capacitance in the element part A11 has a value corresponding to the load being applied to the element part A11, as described above. Therefore, the voltage value of the voltage measurement terminal 27 after elapse of a predetermined period from the closing of the switch 21 becomes a value corresponding to the load being applied to the element part A11. Based on this voltage value, the load of the element part A11 is calculated.

After the switch 21 has been closed only for a certain period, the switch 21 is opened, and the switches 24, 25 are closed. Accordingly, electric charge accumulated in the element part A11 is discharged to the ground via the resistor 26 and the switch 25. When electric charge has been accumulated in other element parts, the electric charge in these element parts is discharged to the ground via the switch 24.

After the discharge has been performed, the switches 24, 25 are opened together with the switch 21. Then, control is shifted to a step in which load detection with respect to the element part A12 at the right of the element part A11 is performed. In this step, in order to apply a voltage to this element part A12, out of the six multiplexers 41 included in the second switchover part 40, the second multiplexer 41 from the top is connected to the ground line L3, and the remaining five multiplexers 41 are connected to the second supply line L2. The states of the six multiplexers 31 included in the first switchover part 30 are maintained as they are.

In this state, the switch 21 is closed only for a certain period, and the voltage VCC is applied to the element part A12. Then, similar to the above, the load on this element part A12 is calculated based on the voltage value of the voltage measurement terminal 27. Then, similar to the above, the switches 24, 25 are closed and discharge is performed.

With respect to the other element parts as well, the first switchover part 30 and the second switchover part 40 are controlled, whereby the voltage VCC is applied to the detection target element part, and the load on the detection target element part is calculated based on the voltage value of the voltage measurement terminal 27. Then, when load detection with respect to all of the element parts has been performed, the same control is performed again from the element part A11, and load detection with respect to each element part in the next routine is performed. In the cases of FIG. 6 to FIG. 8 as well, the load on each element part is detected through similar control.

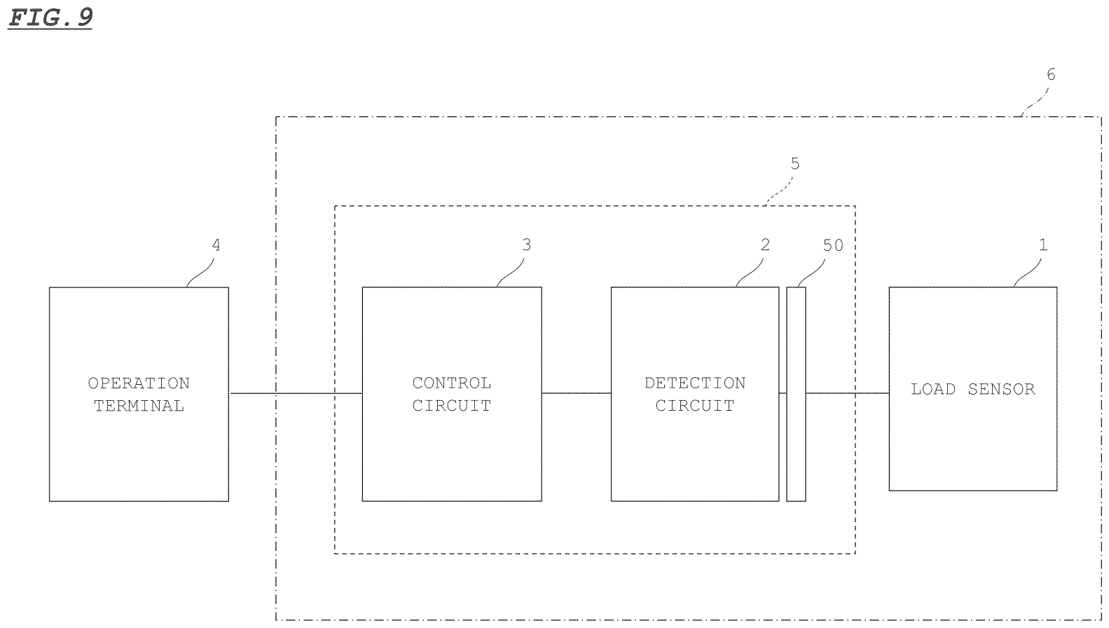

FIG. 9 is a block diagram showing a configuration of a load detection device 6.

The load detection device 6 includes the load sensor 1, the detection circuit 2, and the connector 50 shown in FIG. 5 to FIG. 8, and the control circuit 3. The detection circuit 2, the connector 50, and the control circuit 3 are mounted on the circuit board 5. The control circuit 3 includes an arithmetic processing circuit such as a CPU (Central Processing Unit) and a memory, and controls the detection circuit 2 according to a predetermined program. The control circuit 3 controls the detection circuit 2 as described above, and calculates the load on each element part of the load sensor 1. Further, the control circuit 3 transmits as appropriate various types of information including a detection result of the load, to an operation terminal 4.

The operation terminal 4 is a personal computer, for example. The operation terminal 4 is used for display of information supplied from the control circuit 3 and input of information to the control circuit 3. In the operation terminal 4, an application program for load detection using the load detection device 6 is installed. Through activation of this application program, display of information regarding load detection and input of information can be realized.

The operation terminal 4 is not limited to a personal computer and may be a dedicated terminal. Instead of the operation terminal 4, a display part for displaying information and an input part for inputting information may be provided to the load detection device 6. In this case, the control circuit 3 causes various types of information including a detection result of the load to be displayed on the display part of the load detection device 6.

Meanwhile, in the present embodiment, as shown in FIG. 5 to FIG. 8, a plurality of types of the load sensors 1 between which the numbers of the electrically-conductive elastic bodies 12 and the conductor wires 13 (the electrically-conductive members 13a) are different from each other can be connected to the connector 50. Therefore, the load detection device 6 needs to detect which type of the load sensor 1 is connected and control the first switchover part 30 and the second switchover part 40. In addition, when a wrong type of the load sensor 1 is connected to the connector 50, it is preferable that the load detection device 6 notifies a user of the fact. In the following, these controls will be described.

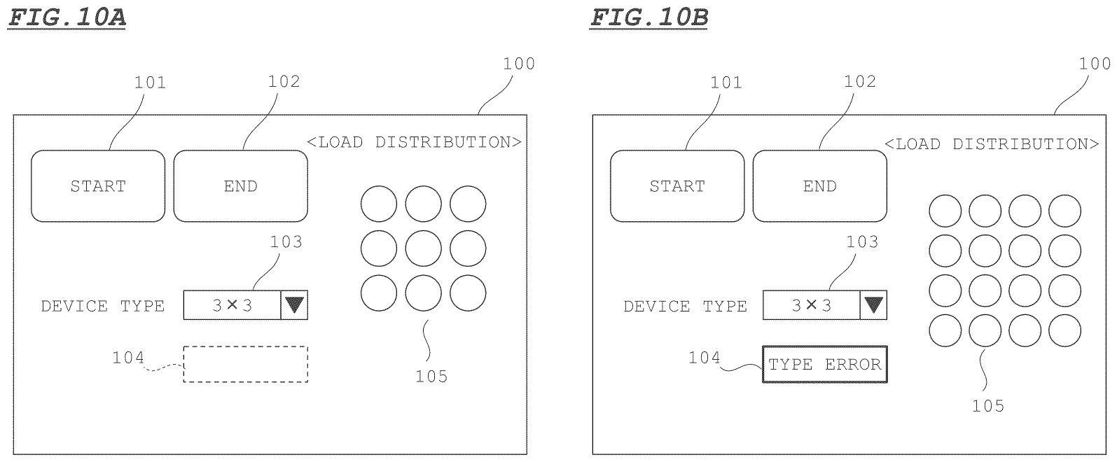

FIGS. 10A, 10B each show an interface screen 100 displayed on the operation terminal 4.

The interface screen 100 includes a start button 101, an end button 102, a type setting item 103, a type error display item 104, and a load distribution display region 105. The user can perform input on the interface screen 100 by using an input means such as a mouse, for example.

The start button 101 and the end button 102 are buttons for inputting start of and end of load detection, respectively. The type setting item 103 is an item for the user to input the type of the load sensor 1 to be used in the load detection.

When a pulldown key of the type setting item 103 is operated, the types of the load sensor 1 as selection candidates are displayed in a pulldown manner. By performing an operation of selecting a desired type from among the types displayed in a pulldown manner, the user can set the type of the load sensor 1 to be used in the load detection. Here, the 3×3 load sensor 1 shown in FIG. 5 is set. The information regarding the set type is transmitted from the operation terminal 4 to the control circuit 3 as appropriate.

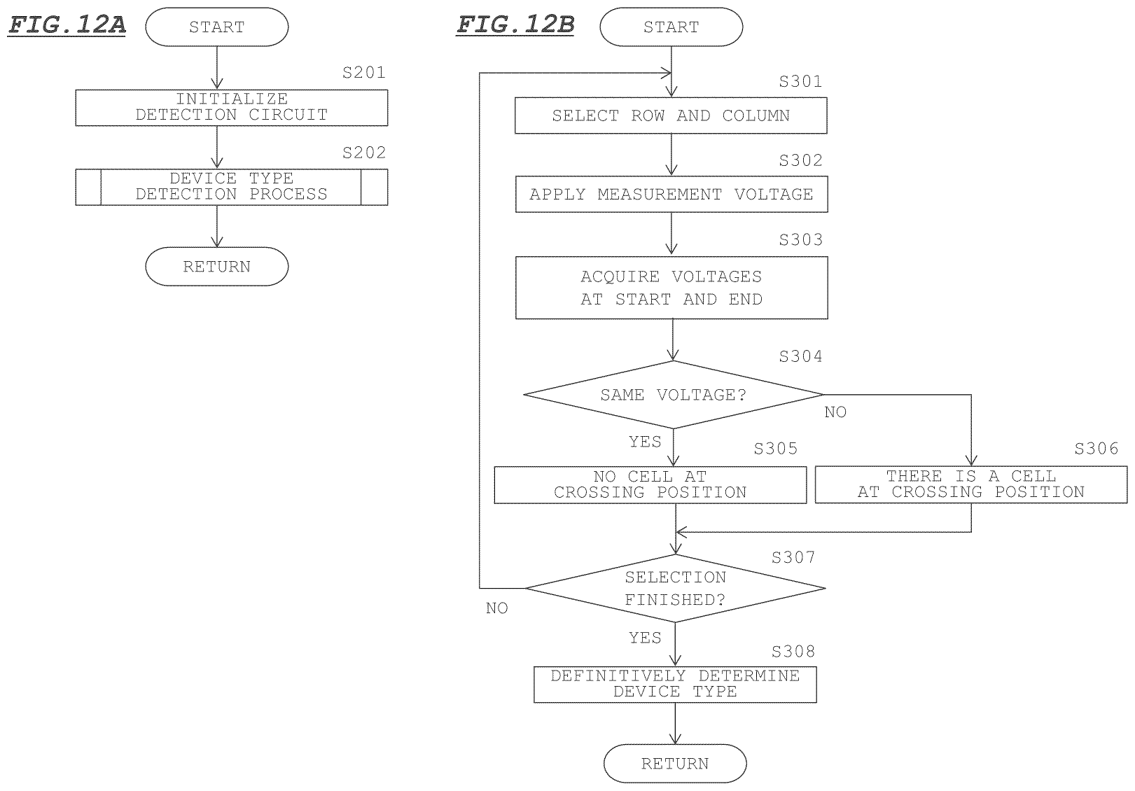

The type error display item 104 is an item for displaying that the type of the load sensor 1 set in the type setting item 103 and the type of the load sensor 1 actually connected to the connector 50 are different from each other, when such an event has occurred. In FIG. 10A, since these types match each other, the type error display item 104 is not displayed. In FIG. 10B, since these types do not match each other, the type error display item 104 for making a notification of mismatch of the types is displayed. The process of detecting the type of the load sensor 1 connected to the connector 50 will be described later with reference to FIG. 12B.

The load distribution display region 105 is a region for displaying a detection result of the load on each element part in the load sensor 1 connected to the connector 50. In the load distribution display region 105, the layout of the element parts on the load sensor 1 is displayed as a plurality of circles arranged in a matrix shape. When a load detection operation has started upon the start button 101 being operated, a color (e.g., a scale color that sequentially changes from red to yellow, and then blue, from the maximum load toward the minimum load) corresponding to the load on each element part is displayed in a corresponding circle.

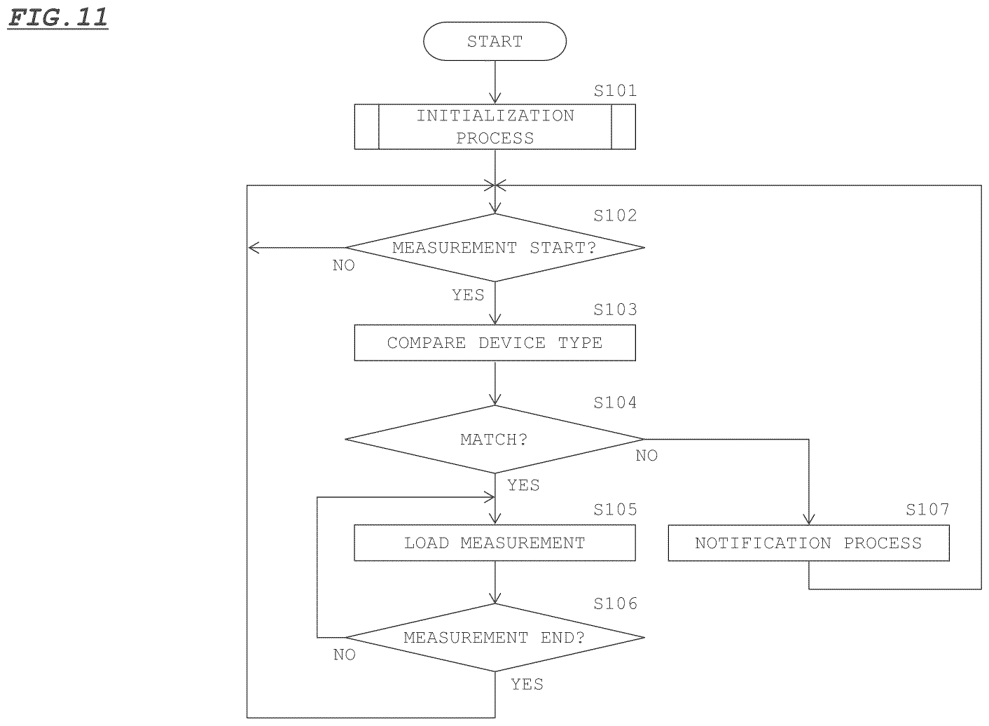

FIG. 11 is a flowchart showing a process executed upon supply of power to the load detection device 6.

Upon supply of power, the control circuit 3 executes a process of initializing the device (S101).

FIG. 12A is a flowchart showing the initialization process.

In the initialization process, the control circuit 3 initializes the detection circuit 2 (S201). In this process, when the load sensor 1 having the maximum size shown in FIG. 8 is connected, the control circuit 3 controls the first switchover part 30, the second switchover part 40, and the switches 21, 24, 25 so that discharge with respect to all of the element parts is performed. Then, the control circuit 3 sets all of the switches 21, 24, 25 to an open state. After having executed the process of initializing the detection circuit 2 in this manner, the control circuit 3 executes a process of detecting the type of the load sensor 1 connected to the connector 50 (S202).

FIG. 12B is a flowchart showing a process of detecting the type of the load sensor 1 executed in step S202 in FIG. 12A.

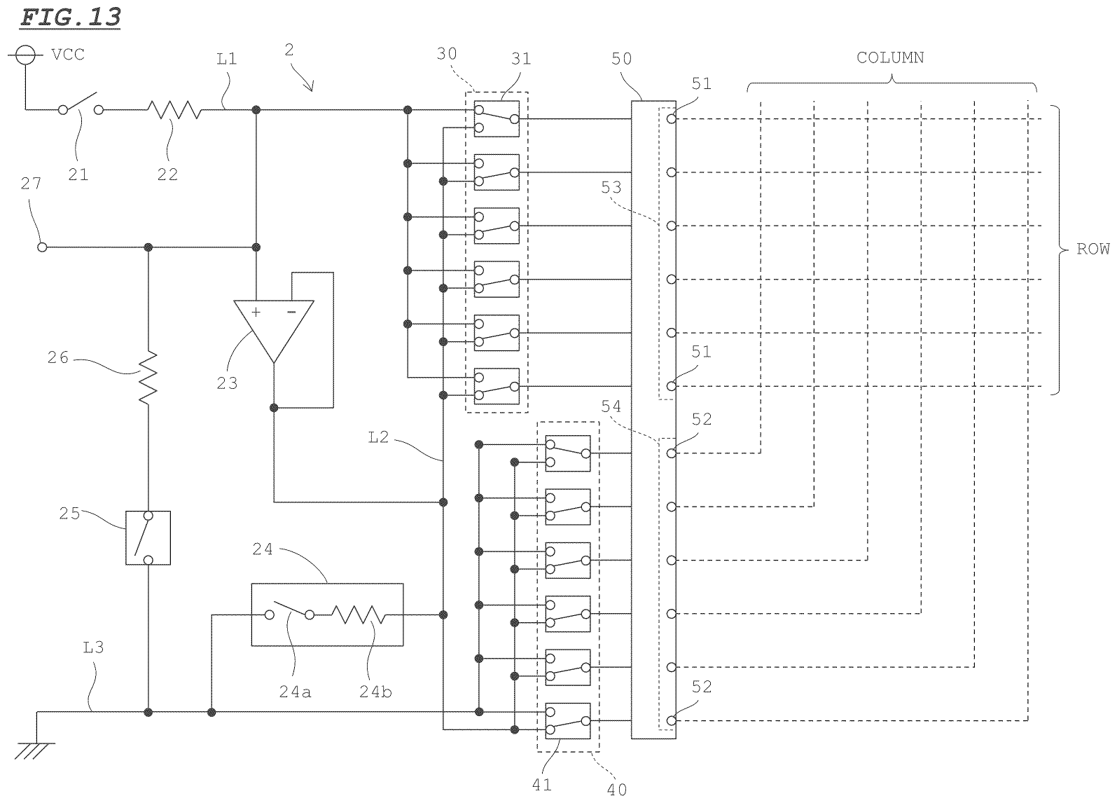

In the process in FIG. 12B, rows and columns are defined as shown in FIG. 13. Here, 6 rows×6 columns are defined. The n-th row from the top corresponds to the n-th first terminal 51 from the top, and the m-th column from the left corresponds to the m-th second terminal 52 from the top.

With reference back to FIG. 12B, the control circuit 3 selects one row and one column (step S301). For example, the control circuit 3 selects the first row from the top and the first column from the left in FIG. 13. Next, the control circuit 3 controls the first switchover part 30, the second switchover part 40, and the switch 21 so that the measurement voltage VCC is applied for a certain period only to the selected row and column (S302). Then, the control circuit 3 acquires the voltages that have respectively occurred in the voltage measurement terminal 27 at the start of the application of and at the end of the application of the measurement voltage VCC (S303), and determines whether or not the acquired two voltages are substantially identical to each other (whether or not the difference therebetween is within an allowable range of variation) (S304).

When the two voltages are substantially identical to each other (S304: YES), the control circuit 3 determines that there is no element part (cell) at the crossing position between the row and the column selected in step S301 (S305). On the other hand, when the two voltages are different from each other (S304: NO), the control circuit 3 determines that there is an element part (cell) at the crossing position between the row and the column selected in step S301 (S306).

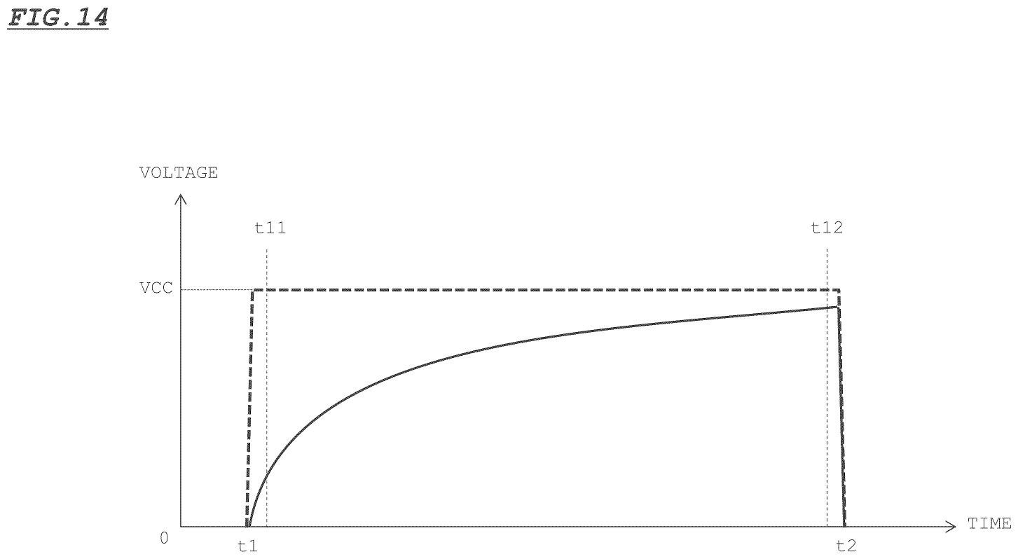

FIG. 14 schematically shows the voltages that respectively occur in the voltage measurement terminal 27 when there is an element part and when there is no element part at the crossing position between the row and the column selected in step S301.

In FIG. 14, the broken line waveform indicates change in the voltage occurring in the voltage measurement terminal 27 when there is no element part at the crossing position between the row and the column, and the solid line waveform indicates change in the voltage occurring in the voltage measurement terminal 27 when there is an element part at the crossing position between the row and the column. t1 is the start timing of the application of the measurement voltage VCC and t2 is the end timing of the application of the measurement voltage VCC.

As indicated by the solid line in FIG. 14, when there is an element part at the crossing position between the selected row and column, the voltage occurring in the voltage measurement terminal 27 gradually increases according to the time constant defined by the capacitance in the element part and the resistor 22 (see FIG. 5). Therefore, a large difference is caused between: the voltage occurring in the voltage measurement terminal 27 at a timing t11 immediately after the start of the application of the measurement voltage VCC; and the voltage occurring in the voltage measurement terminal 27 at a timing t12 immediately before the end of the application of the measurement voltage VCC.

In contrast, when there is no element part at the crossing position between the selected row and column, the first terminal 51 and the second terminal 52 that respectively correspond to these row and column are in a state of being electrically open. Therefore, as indicated by the broken line in FIG. 14, the voltage occurring in the voltage measurement terminal 27 sharply rises to the measurement voltage VCC in response to the start of the application of the measurement voltage VCC, and sharply falls to zero in response to the end of the application of the measurement voltage VCC. Therefore, in this case, the voltage occurring in the voltage measurement terminal 27 at the timing t11 immediately after the start of the application of the measurement voltage VCC, and the voltage occurring in the voltage measurement terminal 27 at the timing t12 immediately before the end of the application of the measurement voltage VCC are substantially identical to each other. Therefore, whether or not there is an element part at the crossing position between the selected row and column can be discerned based on whether or not the voltages at the start of the application of and at the end of the application of the measurement voltage are substantially identical to each other.

With reference back to FIG. 12B, after having performed the process in step S305 or step S306 in accordance with the determination result in step S304, the control circuit 3 determines whether or not the selection has finished with respect to all of the combinations of rows and columns (S307). When the selection has not finished with respect to all of the combinations (S307: NO), the control circuit 3 returns the process to step S301 and selects a row and a column of the next combination. For example, the control circuit 3 newly selects the first row from the top and the second column from the left. Then, after having executed the discharge process with respect to all of the crossing positions between rows and columns, the control circuit 3 executes the processes in step S302 and thereafter in the same manner, and determines whether or not there is an element part (cell) at the crossing position between the selected row and column.

When the process has ended with respect to all of the combinations of rows and columns (S307: YES), the control circuit 3 definitively determines the type of the load sensor 1 connected to the connector 50, based on the presence or absence of an element part (cell) at each of the crossing positions between 6 rows and 6 columns (S308).

For example, when having determined, through the processes in step S301 to step S307, that there are element parts (cells) at the crossing positions between 3 rows and 3 columns, the control circuit 3 definitively determines that the load sensor 1 connected to the connector 50 is of a type in which the element parts are arranged in a matrix shape of 3 rows and 3 columns. That is, the control circuit 3 identifies the type of the load sensor 1 connected to the connector 50, based on the numbers of the rows and columns which have been determined to have element parts (cells).

After having definitively determined the type of the load sensor 1 connected to the connector 50, the control circuit 3 ends the detection process in FIG. 12B and ends the initialization process in FIG. 12A together therewith.

With reference back to FIG. 11, when the initialization process has ended in this manner, the control circuit 3 determines whether or not a measurement start instruction for load has been received from the operation terminal 4. The measurement start instruction is transmitted from the operation terminal 4 to the control circuit 3 in accordance with the start button 101 in FIG. 10A being operated. At this time, the operation terminal 4 transmits, to the control circuit 3, information indicating the type of the load sensor 1 set in the type setting item 103 in FIG. 10A, together with the measurement start instruction.

Upon receiving the measurement start instruction from the operation terminal 4 (S102: YES), the control circuit 3 compares the information indicating the type of the load sensor 1 received together with the measurement start instruction, with the type of the load sensor 1 definitively determined in step S308 in FIG. 12B (S103). Then, when these two types match each other (S104: YES), the control circuit 3 performs a load measurement process in accordance with the definitively determined type of the load sensor 1 (S105).

For example, when the definitively determined type of the load sensor 1 is 3 rows×3 columns, the control circuit 3 performs, using only the first terminals 51 and the second terminals 52 that correspond to these rows and columns, detection of the loads on the element parts in the 3 rows×3 columns. The detection result of the loads is transmitted from the control circuit 3 to the operation terminal 4 as needed, and is reflected in the load distribution display region 105 in FIG. 10A.

Until receiving a measurement end instruction from the operation terminal 4 (S106: NO), the control circuit 3 continues the load measurement process. The measurement end instruction is transmitted from the operation terminal 4 to the control circuit 3 in accordance with the end button 102 in FIG. 10A being operated. Upon receiving the measurement end instruction (S106: YES), the control circuit 3 ends the measurement operation and returns the process to step S102.

On the other hand, when the type of the load sensor 1 received from the operation terminal 4 and the type of the load sensor 1 definitively determined in step S308 in FIG. 12B do not match each other (S104: NO), the control circuit 3 performs a process for making a notification of the fact (S107). That is, the control circuit 3 transmits, to the operation terminal 4, information indicating that these two types do not match each other. Upon receiving this, the operation terminal 4 causes the type error display item 104 to be displayed on the interface screen 100 as shown in FIG. 10B, for example. Accordingly, the user can understand that the type of the load sensor 1 set by the user and the type of the load sensor 1 actually connected are different from each other.

Then, after performing the notification process, the control circuit 3 returns the process to step S102, and waits for a measurement start instruction to be received from the operation terminal 4. During this time, the user corrects the setting of the type setting item 103 in FIG. 10A to an appropriate setting, for example. Then, upon the start button 101 being operated, the information indicating the type of the load sensor 1 and a measurement start instruction are transmitted from the operation terminal 4 to the control circuit 3. Accordingly, the determination in the step S102 becomes YES, and the same process above is executed.

### Effects of Embodiment

According to the present embodiment, the following effects are exhibited.

As shown in FIG. 5 to FIG. 8, the connector 50 includes the first terminals 51 and the second terminals 52 in numbers that can cope with a plurality of types of the load sensor 1 between which the numbers of the electrically-conductive members 13a (first electrode) and the electrically-conductive elastic bodies 12 (second electrode) are different from each other. Therefore, even when the type of the load sensor 1 to be used is changed, it is possible to cope with the load sensor 1 by the same connector 50. As shown in FIG. 12B, the control circuit 3 detects a combination (row, column) of the first terminal 51 and the second terminal 52, out of the plurality of first terminals 51 and the plurality of second terminals 52, to which the electrically-conductive member 13a (first electrode) and the electrically-conductive elastic body (second electrode) are respectively connected. Therefore, whichever type of the load sensor 1 is connected to the connector 50, load detection can be smoothly performed by the same circuitry (the detection circuit 2, the control circuit 3).

As shown in FIG. 12B, the control circuit 3 controls the detection circuit 2 so that the measurement voltage VCC is applied, in order, to the combinations of the plurality of first terminals 51 whose connection targets are the electrically-conductive members 13a (first electrode) and the plurality of second terminals 52 whose connection targets are the electrically-conductive elastic bodies 12 (second electrode) (S301, S302), and based on change in the voltage detected by the detection circuit 2 in each of the combinations (S304), detects a combination (row, column) of the first terminal 51 and the second terminal 52 to which the electrically-conductive member 13a (first electrode) and the electrically-conductive elastic body 12 (second electrode) are respectively connected (S305).

More specifically, as shown in FIG. 14, the control circuit 3 applies the measurement voltage VCC (constant voltage) to each combination (row, column) for a predetermined period, and based on whether or not the voltage at the start of the application (the timing t11) of and the voltage at the end of the application (the timing t12) of the measurement voltage VCC (constant voltage) are substantially identical to each other, detects a combination (row, column) of the first terminal 51 and the second terminal 52 to which the electrically-conductive member 13a (first electrode) and the electrically-conductive elastic body 12 (second electrode) are respectively connected. Accordingly, the combination (row, column) of the first terminal 51 and the second terminal 52 to which the electrically-conductive member 13a (first electrode) and the electrically-conductive elastic body 12 (second electrode) are connected can be easily and smoothly detected.

As shown in FIG. 12B, the control circuit 3 determines the type of the load sensor 1 connected to the connector 50, based on the detection result of the combination of the first terminal 51 and the second terminal 52, out of the plurality of first terminals 51 and the plurality of second terminals 52, to which the electrically-conductive member 13a (first electrode) and the electrically-conductive elastic body 12 (second electrode) are respectively connected (S308). Accordingly, the type of the load sensor 1 actually connected to the connector 50 can be smoothly determined.

As shown in FIG. 11, the control circuit 3 acquires, from the operation terminal 4, information regarding the type of the load sensor 1 inputted by the user, together with the measurement start instruction (S102), and based on a fact that the type of the load sensor 1 inputted by the user and the type of the load sensor 1 detected through application of a voltage to the combination of the first terminal 51 and the second terminal 52 do not match each other (S104: NO), the control circuit 3 executes a process of making a notification of the mismatch (S107). Accordingly, the user can understand that the type of the load sensor 1 set by the user and the type of the load sensor 1 actually connected are different from each other, and can smoothly take an appropriate measure.

### Modification 1

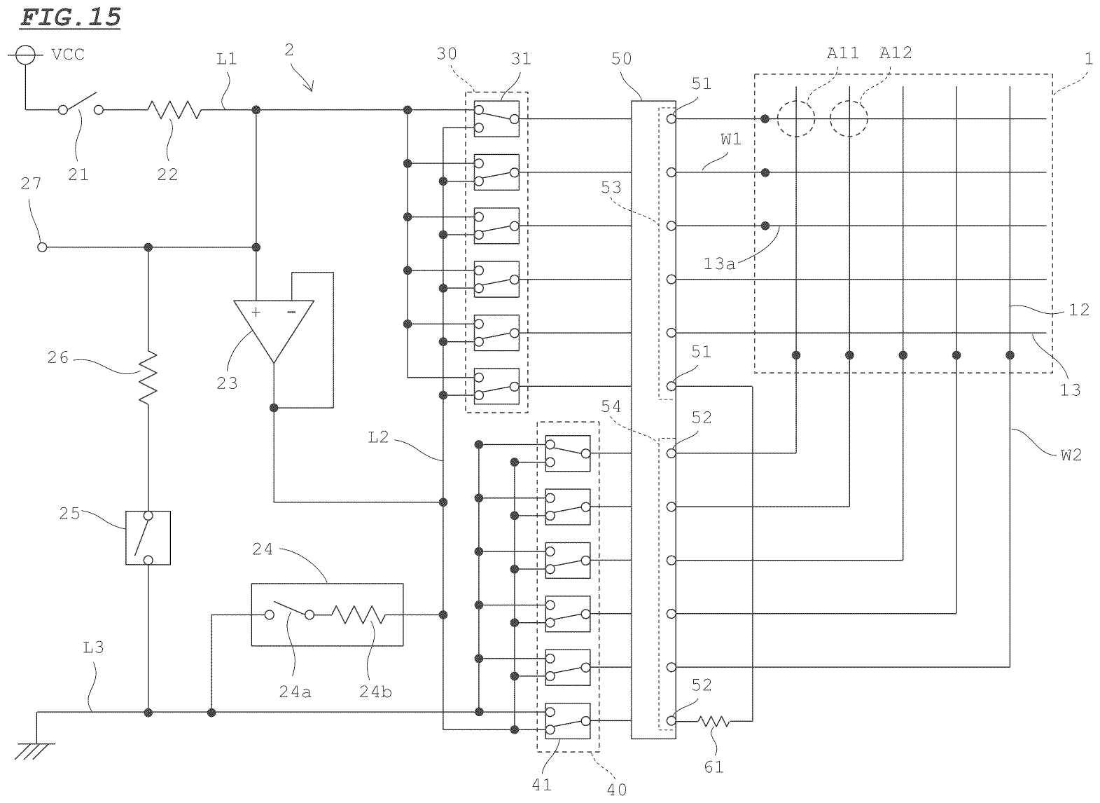

FIG. 15 is a circuit diagram showing a configuration of the detection circuit 2 according to Modification 1.

As shown in FIG. 15, in Modification 1, a resistor 61 is connected to a combination, out of the combinations of the first terminals 51 and the second terminals 52, in which the electrically-conductive member 13a and the electrically-conductive elastic body 12 are not connected. For example, to the first terminal 51 and the second terminal 52 of the combination in which the electrically-conductive member 13a and the electrically-conductive elastic body 12 are not connected, both ends of a flexible printed wiring board having the resistor 61 are connected.

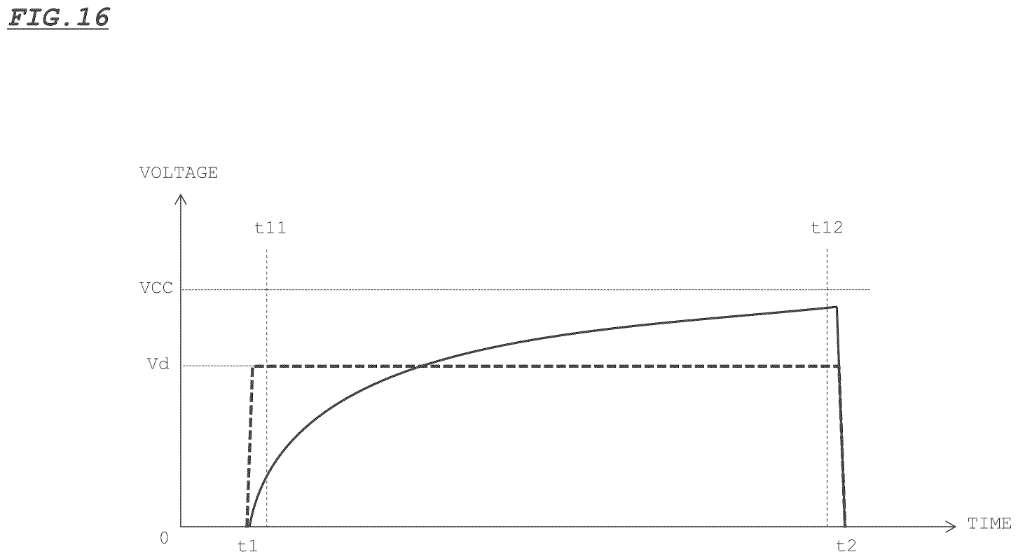

FIG. 16 schematically shows the voltages that respectively occur in the voltage measurement terminal 27 when there is an element part and when there is no element part at the crossing position between the selected row and column according to Modification 1.

In Modification 1, the resistor 61 is connected as shown in FIG. 15 between the first terminal 51 and the second terminal 52 respectively connected to a row and a column in which there is no element part. Therefore, when the measurement voltage VCC is applied, with this row and column set as the target, a voltage Vd obtained by dividing the measurement voltage VCC between the resistor 22 and the resistor 61 occurs in the voltage measurement terminal 27.

In this case as well, the voltages occurring in the voltage measurement terminal 27 at the timings t11, t12 are substantially identical to each other. Therefore, through a process similar to that in FIG. 12B, whether or not there is an element part (cell) at the crossing position between the row and the column can be discerned. Further, in the configuration of Modification 1, the voltage Vd is lower than the measurement voltage VCC. Therefore, based on whether or not the voltages occurring in the voltage measurement terminal 27 at the timings t11, t12 are substantially identical to each other and are lower than the measurement voltage VCC (whether or not said voltages are substantially identical to the voltage Vd obtained by dividing the measurement voltage VCC between the resistor 22 and the resistor 61), the presence or absence of an element part (cell) at the crossing position between the row and column as the processing target can be more accurately determined.

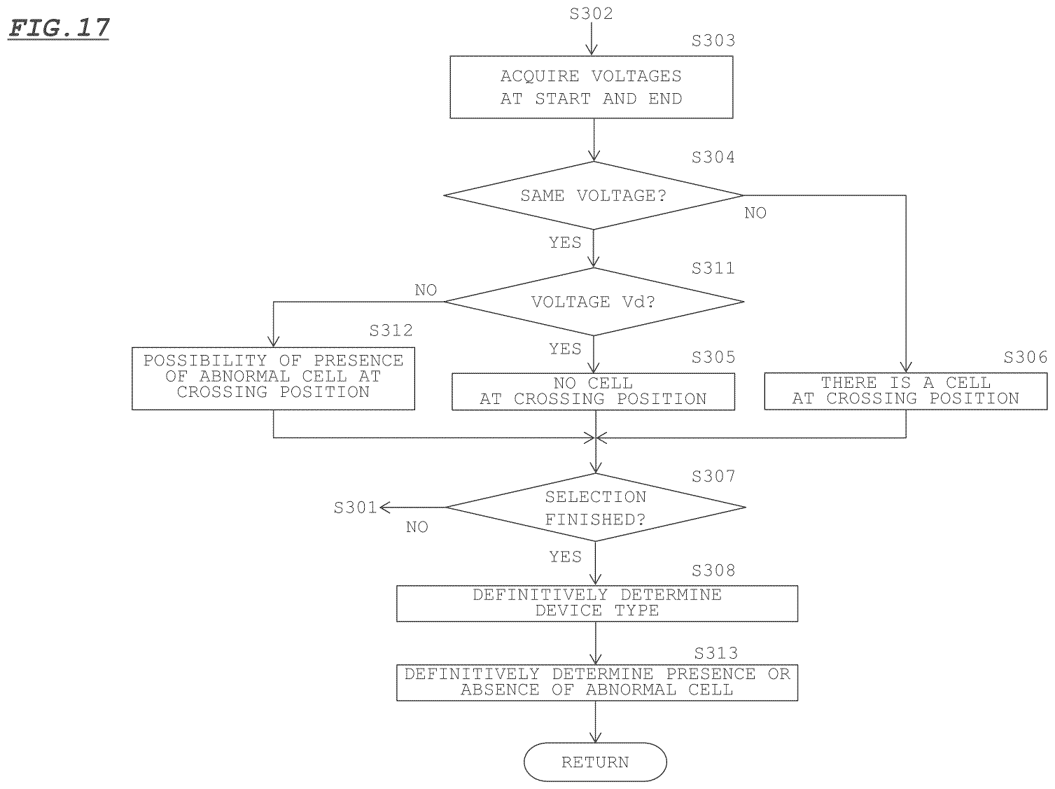

In this case, the process in FIG. 12B can be changed as in FIG. 17. For convenience, in FIG. 17, processes in step S303 and thereafter in FIG. 12B are shown. The processes in steps S301, S302 are the same as those in FIG. 12B. Here, steps S311 to S313 are added.

When the voltages occurring in the voltage measurement terminal 27 at the timings t11, t12 in FIG. 16 are substantially identical to each other (S304: YES), the control circuit 3 further determines whether or not these voltages are substantially identical to the voltage Vd obtained by dividing the measurement voltage VCC between the resistor 22 and the resistor 61 (whether or not the difference therebetween is within an allowable range of variation) (S311).

When these voltages are substantially identical to the voltage Vd (S311: YES), the control circuit 3 determines that there is no element part (cell) at the crossing position between the row and the column selected in step S301 (see FIG. 12B) (S305). On the other hand, when these voltages are not substantially identical to the voltage Vd (S311: NO), the control circuit 3 determines that there is a possibility of presence of an element part (cell) in which an abnormality such as disconnection has occurred at the crossing position between the row and the column selected in step S301 (see FIG. 12) (S312).

For example, when disconnection has occurred in that element part, the voltages occurring in the voltage measurement terminal 27 at the timings t11, t12 are substantially identical to the measurement voltage VCC, as in the case of FIG. 14. In such a case, the determination in step S311 becomes NO.

In this case, after the determination in step S307 becomes YES, the control circuit 3 definitively determines whether or not an abnormal element part is present at this crossing position, from the relationship with the element parts detected through step S306 (S313). For example, when this crossing position is included in the crossing positions between the rows and the columns of the detected element parts, the control circuit 3 definitively determines that an abnormal element part is present at this crossing position. On the other hand, when this crossing position is not included in the above crossing positions, the control circuit 3 definitively determines that no element part is present at this crossing position.

Through this process, when having definitively determined that there is an abnormality in the element part, the control circuit 3 outputs, to the operation terminal 4, information for making a notification of the element part (cell) in which an abnormality has occurred. Based on reception of this information, the operation terminal 4 executes a process of notifying the user of the element part in which an abnormality has been detected.

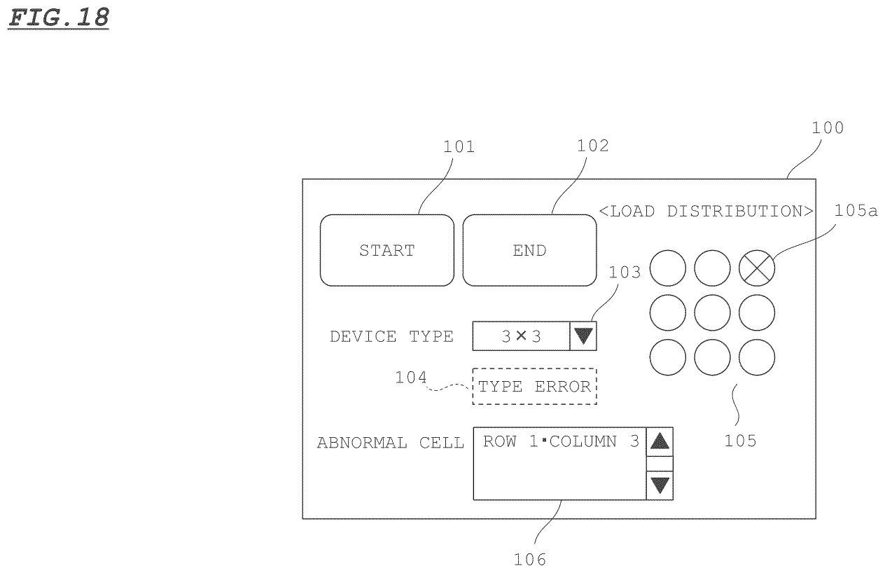

In this case, for example, the interface screen 100 shown in FIG. 18 is displayed on the operation terminal 4. This interface screen 100 includes a notification item 106 for making a notification of the element part (cell) in which an abnormality has been detected. In this notification item 106, the element part (cell) corresponding to the abnormality notification information received from the control circuit 3 is displayed. Here, it is indicated that an abnormality has occurred in the element part at the first row and the third column. Further, in the load distribution display region 105, an x mark indicating that an abnormality has occurred is superposed on a circle 105a at the position corresponding to the element part in which an abnormality has occurred. The user refers to these pieces of information displayed on the interface screen 100, thereby being able to understand that an abnormality has occurred in a certain element part and the position of this element part.

### Modification 2

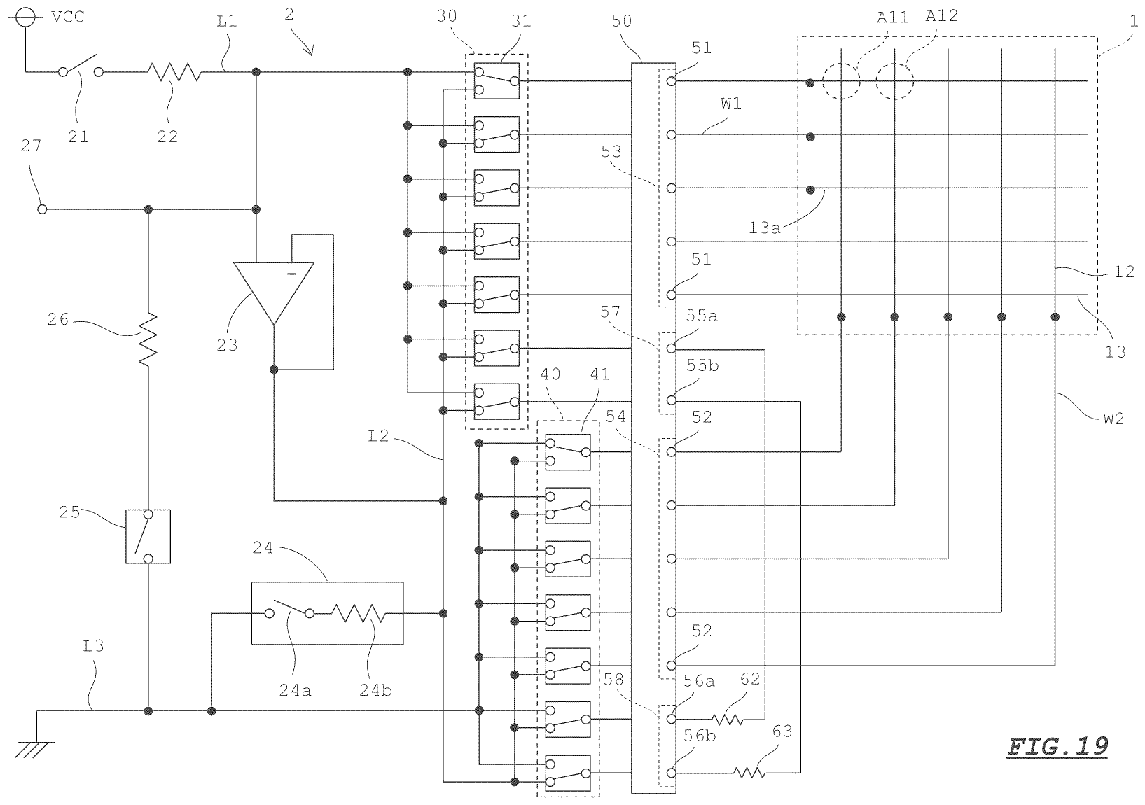

FIG. 19 is a circuit diagram showing a configuration of the detection circuit 2 according to Modification 2.

In Modification 2, the first connection part 53 and the second connection part 54 respectively include five first terminals 51 and five second terminals 52. Therefore, in Modification 2, up to the load sensor 1 having a size of 5 rows×5 columns can be connected to the connector 50. Further, in Modification 2, a third connection part 57 and a fourth connection part 58 are disposed on the connector 50. Two identification terminals 55a, 55b are disposed at the third connection part 57, and two identification terminals 56a, 56b are disposed at the fourth connection part 58. The identification terminals 55a, 56a are used as a pair, and the identification terminals 55b, 56b are used as a pair.

A resistor 62 is disposed between the identification terminals 55a, 56a serving as a pair, and a resistor 63 is disposed between the identification terminals 55b, 56b serving as a pair. The resistance values of the resistors 62, 63 are changed in accordance with the type of the load sensor 1 connected to the first terminals 51 and the second terminals 52.

The voltage occurring in the voltage measurement terminal 27 when the measurement voltage VCC has been applied to the identification terminals 55a, 56a serving as a pair has a value corresponding to the resistance value of the resistor 62 as shown in FIG. 16. Similarly, the voltage occurring in the voltage measurement terminal 27 when the measurement voltage VCC has been applied to the identification terminals 55b, 56b serving as a pair also has a value corresponding to the resistance value of the resistor 63.

For example, if the resistance value of the resistor 62 is set to either one of R1 and R2, a voltage Va occurring in the voltage measurement terminal 27 when the measurement voltage VCC has been applied to the identification terminals 55a, 56a serving as a pair can be set to either one of V1 and V2. Similarly, if the resistance value of the resistor 63 is set to either one of R1 and R2, a voltage Vb occurring in the voltage measurement terminal 27 when the measurement voltage VCC has been applied to the identification terminals 55b, 56b serving as a pair can be set to either one of V1 and V2.

Therefore, in this case, there are four combinations of the voltages Va, Vb. When the type of the load sensor 1 is associated with these four combinations, the type of the load sensor 1 can be expressed in terms of the resistance values of the resistors 62, 63, as shown in the table below.

| | Type 1 | Type 2 | Type 3 | Type 4 |
|---|---|---|---|---|
| | (2 × 2) | (3 × 3) | (4 × 4) | (5 × 5) |
| Resistor 62 | R1 | R1 | R2 | R2 |
| Resistor 63 | R1 | R2 | R1 | R2 |
| Voltage Va | V1 | V1 | V2 | V2 |
| Voltage Vb | V1 | V2 | V1 | V2 |

Here, four types of the load sensor 1 are expressed in terms of the resistance values of the resistors 62, 63. For example, when the types of the resistance values of the resistors 62, 63 are set to three types or more, a larger number of types of the load sensor 1 can be expressed in terms of the resistance values of the resistors 62, 63.

In Modification 2, when a load sensor 1 is connected to the connector 50, the resistors 62, 63 having resistance values corresponding to the type of this load sensor 1 are further connected between the identification terminals 55a, 56a and between the identification terminals 55b, 56b, respectively. Accordingly, by referring to the voltages Va, Vb occurring in the voltage measurement terminal 27 when the measurement voltage VCC has been applied to each of the pairs of these identification terminals 55a, 56a and identification terminals 55b, 56b, the control circuit 3 can identify the type of the load sensor 1 connected to the connector 50.

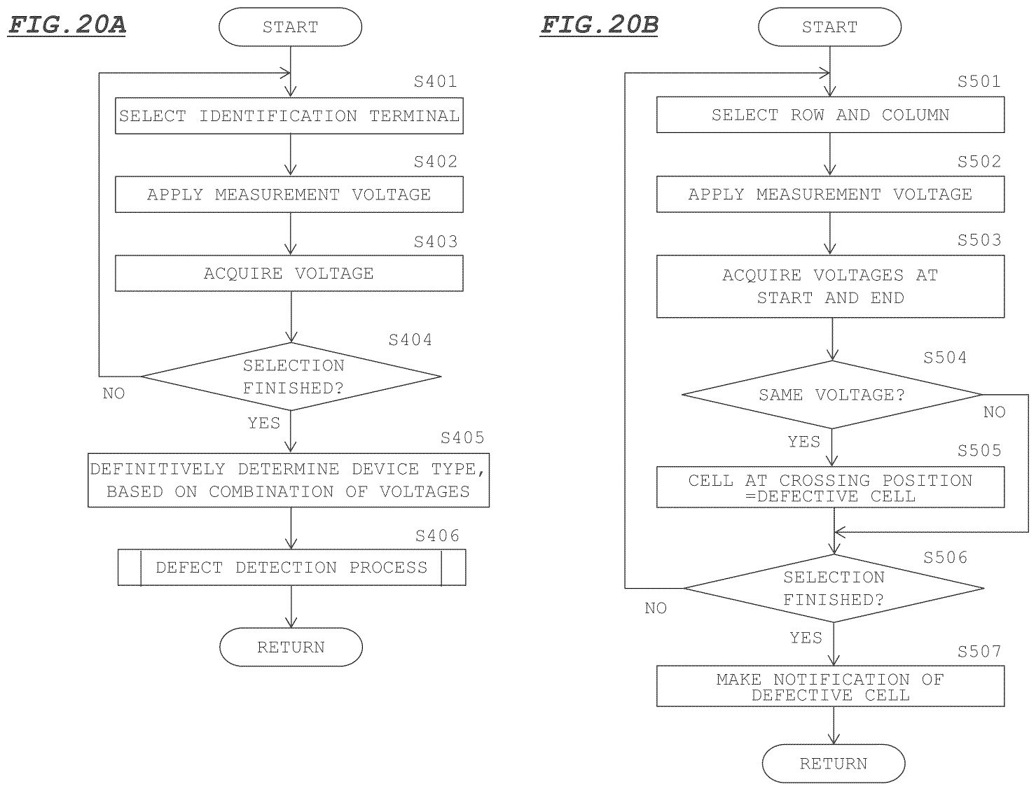

FIG. 20A is a flowchart showing a process of determining the type of the load sensor 1 according to Modification 2. This process is executed instead of the process in FIG. 12B.

The control circuit 3 selects the identification terminals 55a, 56a out of the two pairs of identification terminals (S401), and executes control of applying, for a certain period, the measurement voltage VCC to the identification terminals 55a, 56a of the selected pair (S402). The control circuit 3 acquires the voltage Va near the middle of the application period of the measurement voltage VCC, for example (S403).

Then, the control circuit 3 determines whether or not both of the two pairs of identification terminals have been selected (S404). When both have not been selected (S404: NO), the control circuit 3 selects the other pair of the identification terminals 55b, 56b (S401), and executes the same process. Accordingly, the control circuit 3 acquires the voltage Vb (S403). Then, when the process with respect to the two identification terminals has ended (S404: YES), the control circuit 3 definitively determines the type of the load sensor 1 connected to the connector 50, according to the information in Table 1 above, based on the combination of the voltages Va, Vb acquired through the above process (S405). Then, the control circuit 3 executes a process of detecting a defect of each element part (cell) on the load sensor 1 connected to the connector 50 (S406).

FIG. 20B is a flowchart showing a defect detection process in step S406 in FIG. 20A.

In accordance with the type of the load sensor 1 definitively determined in step S405 in FIG. 20A, the control circuit 3 selects one of the combinations (row, column) of a plurality of the first terminals 51 to which the electrically-conductive members 13a are connected and a plurality of the second terminal 52 to which the electrically-conductive elastic bodies 12 are connected (S501), and applies the measurement voltage VCC to the selected combination for a certain period (S502). Next, the control circuit 3 acquires the voltages at the start of the application of and at the end of the application of the measurement voltage VCC (S503), and determines whether or not these two voltages are substantially identical to each other (S504).

When there is no abnormality in the element part at the crossing position between the row and column selected in step S501, the voltage occurring in the voltage measurement terminal 27 changes as indicated by the solid line in FIG. 14 due to application of the measurement voltage VCC in step S502. Therefore, in this case, there is a large difference between the two voltages acquired in step S503. On the other hand, when there is an abnormality such as disconnection in the element part at the crossing position between the row and column selected in step S501, the voltage occurring in the voltage measurement terminal 27 changes as indicated by the broken line in FIG. 14 due to application of the measurement voltage VCC in step S502. Therefore, in this case, the two voltages acquired in step S503 are substantially identical to each other.

When these two voltages are substantially identical to each other (S504: YES), the control circuit 3 sets the element part (cell) at this crossing position to be a defective cell (S505). On the other hand, when these two voltages are not substantially identical to each other (S504: NO), the control circuit 3 advances the process to step S506 without setting the element part (cell) at this crossing position to be a defective cell.

The control circuit 3 executes the processes in step S501 to S505 with respect to all of the combinations (row, column) of the plurality of the first terminals 51 to which the electrically-conductive members 13a are connected and the plurality of the second terminals 52 to which the electrically-conductive elastic bodies 12 are connected (S506). Then, when the process has ended with respect to all of the combinations (S506: YES), the control circuit 3 transmits information indicating all of the element parts (cell) that have been set to be defective cells in step S505, to the operation terminal 4 (S507), and ends the process in FIG. 20B. When none of the element parts has been set to a defective cell, the control circuit 3 ends the process without executing the notification process in step S507.

When having received, from the control circuit 3, the information indicating an element part set as a defective cell, the operation terminal 4 performs display for making a notification thereof, on the interface screen 100. In this case, for example, as in FIG. 18, the notification item 106 showing the element part set as a defective cell is included in the interface screen 100, and further, x is provided to the circle corresponding to the element part in the load distribution display region 105. Accordingly, the user can understand that an abnormality has occurred in a certain element part, and the position of this element part.

According to Modification 2, the type of the load sensor 1 connected to the connector 50 is detected based on the voltage outputted from the detection circuit 2 (the voltage measurement terminal 27) when the measurement voltage VCC has been applied to the identification terminals serving as a pair. Therefore, unlike the embodiment above, it is not necessary to apply a voltage to all of the combinations of rows and columns. Therefore, the type of the load sensor 1 connected to the connector 50 can be detected more easily and quickly.

In the above, two pairs of identification terminals are set to the connector 50. However, the number of the pairs of the identification terminals set to the connector 50 need not necessarily be two, and may be one, three, or more. When the number of the pairs of the identification terminals set to the connector 50 is increased, a larger number of types of the load sensors 1 can be coped with.

### Other Modifications

In the embodiment above, as the type of the load sensor 1 that can be connected to the connector 50, four types are shown in FIG. 5 to FIG. 8. However, the type of the load sensor 1 that can be connected to the connector 50 is not limited thereto. For example, the connector 50, the first switchover part 30, and the second switchover part 40 may be configured such that the load sensor 1 that has a larger number of rows and columns can be connected. For example, the connector 50, the first switchover part 30, and the second switchover part 40 may be configured such that the load sensor 1 in which element parts are arranged in 32 rows×32 columns can be connected.

In this case, the load detection device 6 can cope with the load sensor 1 of each type having 32 rows×32 columns or less, through the control similar to that in FIG. 11 to FIG. 12B. To this configuration as well, the configurations of Modifications 1, 2 may be applied. When the configuration of Modification 2 is applied to this configuration, the number of the types of the load sensors 1 that can be coped with increases. Therefore, it is preferable to increase the number of the pairs of the identification terminals to three or more. In this case as well, through the control similar to that in FIGS. 20A, 20B, from the voltage measurement result with respect to each pair, the type of the load sensor 1 connected to the connector 50 can be smoothly detected, and an element part that has a defect can be smoothly detected.

In the embodiment above, as shown in FIG. 9, the detection circuit 2, the connector 50, and the control circuit 3 are mounted on the same circuit board 5. However, these need not necessarily be mounted on the same circuit board. For example, the detection circuit 2 and the connector 50 may be mounted on the same circuit board, and the control circuit 3 may be mounted on another circuit board.

The configuration of the detection circuit 2 is not limited to the configuration shown in FIG. 5. As long as it is possible to detect change in the voltage during application of the measurement voltage VCC to the element part, the configuration of the detection circuit 2 can be changed as appropriate.

The first switchover part 30 and the second switchover part 40 are implemented by the multiplexers 31, 41, but the first switchover part 30 and the second switchover part 40 may be implemented by switchover circuits other than multiplexers.

The control performed by the control circuit 3 is not limited to the contents shown in the embodiment and Modifications 1, 2 above, and can be changed as appropriate.

For example, in the embodiment above, in the initialization process performed upon supply of power, the process in FIG. 12B is performed. However, for example, at the timing when a load measurement instruction has been first inputted after power has been supplied, the process in FIG. 12B may be performed. Alternatively, the process in FIG. 12B may be performed every time the load measurement instruction is inputted.

Similarly, the processes in FIGS. 20A, 20B shown in Modification 2 also need not necessarily be executed in the initialization process upon supply of power, and may be performed at a timing, for example, when the load measurement instruction has been first inputted after power has been supplied. The detection process of the defective cell in FIG. 20B may be performed at a constant cycle during load measurement.

In the embodiment above, as shown in FIG. 11, comparison between the type of the load sensor 1 set by the user and the type of the load sensor 1 definitively determined, by the control circuit 3, to be connected to the connector 50 is performed in accordance with input of the measurement start instruction. However, this comparison may be performed during the initialization process. In this case, the control circuit 3 may acquire information indicating the type of the load sensor 1 set by the user, from the operation terminal 4 during the initialization process.

In the embodiment above, as shown in FIG. 14, the presence or absence of an element part is detected based on whether or not the voltages acquired at the voltage application start (the timing t11) and at the voltage application end (the timing t12) are substantially identical to each other. However, the method for detecting the presence or absence of an element part on the basis of voltage is not limited thereto. For example, whether or not there is an element part at the crossing position between the row and column serving as the processing target may be detected, based on whether or not the voltage having occurred in the voltage measurement terminal 27 at the voltage application start (the timing t11) is substantially identical to the measurement voltage VCC. In this case, when the voltage having occurred in the voltage measurement terminal 27 at the voltage application start (the timing t11) is substantially identical to the measurement voltage VCC, it is discerned that there is no element part at the crossing position between the row and the column serving as the processing target. Similarly, in Modification 1 shown in FIG. 16 as well, whether or not there is an element part at the crossing position between the row and column serving as the processing target may be detected, based on whether or not the voltage having occurred in the voltage measurement terminal 27 at the voltage application start (the timing t11) is substantially identical to the voltage Vd.

The process by the control circuit 3 shown in the embodiment and Modifications 1, 2 above may be performed by being apportioned to two control circuits included in the load detection device 6. Alternatively, the process by the control circuit 3 shown in the embodiment and Modifications 1, 2 above may be performed by being apportioned to the control circuit 3 and a control circuit on the operation terminal 4 side. In this case, the control circuit 3 and the control circuit on the operation terminal 4 side form the control circuit of the present invention, and the load sensor 1, the connector 50, the detection circuit 2, the control circuit 3, and the operation terminal 4 form a load detection device.

In the embodiment above, the conductor wire 13 is implemented by a covered copper wire. However, not limited thereto, the conductor wire 13 may be implemented by a linear-shaped electrically-conductive member formed of a substance other than copper, and a dielectric body covering the electrically-conductive member. The electrically-conductive member may be implemented by a twisted wire. In the embodiment above, the conductor wire 13 extends in a straight line shape, but the conductor wire 13 may meander in the Y-axis direction.

In the embodiment above, the electrically-conductive elastic bodies 12 are provided only on the face on the Z-axis positive side of the base member 11. However, the electrically-conductive elastic bodies may be provided also on the face on the Z-axis negative side of the base member 15. In this case, the electrically-conductive elastic bodies on the base member 15 side are configured similar to the electrically-conductive elastic bodies 12 on the base member 11 side, and in a plan view, are disposed so as to be superposed on the electrically-conductive elastic bodies 12 with the conductor wires 13 sandwiched therebetween. Then, wiring cables drawn from the electrically-conductive elastic bodies on the base member 15 side are connected to the wiring cables W2 drawn from the electrically-conductive elastic bodies 12 opposing in the Z-axis direction. When the electrically-conductive elastic bodies are provided above and below the conductor wires 13 like this, change in the capacitance in each element part becomes substantially twice in accordance with the upper and lower electrically-conductive elastic bodies. Thus, the detection sensitivity of the load applied to the element part can be enhanced.

In the embodiment above, the dielectric body 13b is formed on the electrically-conductive member 13a so as to cover the outer periphery of the electrically-conductive member 13a. However, instead of this, the dielectric body 13b may be formed on the upper face of the electrically-conductive elastic body 12. In this case, in accordance with application of a load, the electrically-conductive member 13a sinks in so as to be wrapped by the electrically-conductive elastic body 12 and the dielectric body 13b, and the contact area between the electrically-conductive member 13a and the electrically-conductive elastic body 12 changes. Accordingly, similar to the embodiment above, the load applied to the element part can be detected.

In the embodiment above, each element part is formed by the electrically-conductive elastic body 12 and the conductor wire 13 crossing each other. However, the configuration of the element part is not limited thereto. For example, the element part may be formed by a hemisphere-shaped electrically-conductive elastic body and a flat plate-shaped electrode sandwiching a dielectric body therebetween. In this case, the dielectric body may be formed on the surface of the electrode opposing the electrically-conductive elastic body, or may be formed on the surface of the hemisphere-shaped electrically-conductive elastic body.

In addition to the above, various modifications can be made as appropriate to the embodiment of the present invention without departing from the scope of the technical idea defined by the claims.

What is claimed is:

1. A load detection device comprising:
a load sensor including at least one first electrode, at least one second electrode disposed so as to cross the first electrode, and a dielectric body present between the first electrode and the second electrode;
a detection circuit configured to detect change in a voltage in a crossing position between the first electrode and the second electrode;
a connector configured to connect the first electrode and the second electrode to the detection circuit; and
a control circuit configured to control the detection circuit, and configured to detect a load applied at the crossing position, based on change in a voltage detected by the detection circuit, wherein
the connector includes a plurality of terminals in a number that can cope with a plurality of types of the load sensors between which numbers of the first electrode and the second electrode are different from each other, and
the control circuit executes control of detecting a combination of, out of the plurality of terminals, the terminals to which the first electrode and the second electrode are respectively connected.

2. The load detection device according to claim 1, wherein
the control circuit
controls the detection circuit so that a voltage is applied, in order, to combinations of a plurality of the terminals whose connection target is the first electrode and a plurality of the terminals whose connection target is the second electrode, and
detects the combination of the terminals to which the first electrode and the second electrode are respectively connected, based on change in a voltage detected by the detection circuit in each of the combinations.

3. The load detection device according to claim 2, wherein
the control circuit applies a constant voltage to each of the combinations for a predetermined period, and based on whether or not a voltage at start of application of and a voltage at end of application of the constant voltage are substantially identical to each other, detects the combination of the terminals to which the first electrode and the second electrode are respectively connected.

4. The load detection device according to claim 1, wherein
a resistor is connected in a combination, out of combinations of a plurality of the terminals whose connection target is the first electrode and a plurality of the terminals whose connection target is the second electrode, in which the first electrode or the second electrode is not connected.

5. The load detection device according to claim 1, wherein
the control circuit determines a type of the load sensor connected to the connector, based on a detection result of the combination of, out of the plurality of terminals, the terminals to which the first electrode and the second electrode are respectively connected.

6. The load detection device according to claim 1, wherein
the connector includes a pair of identification terminals for identifying a type of the load sensor,
a resistor having a resistance value corresponding to the type of the load sensor connected to the connector is connected between the pair of identification terminals, and
the control circuit
controls the detection circuit so that a voltage is applied to the pair of identification terminals, and
detects the type of the load sensor connected to the connector, based on a voltage outputted from the detection circuit when the voltage is applied to the pair of identification terminals.

7. The load detection device according to claim 6, wherein
the control circuit
controls, in accordance with the detected type of the load sensor, the detection circuit so that a voltage is applied, in order, to combinations of a plurality of the terminals whose connection target is the first electrode and a plurality of the terminals whose connection target is the second electrode, and
determines, based on a voltage detected by the detection circuit in each of the combinations, presence or absence of an abnormality at each of the crossing positions in the load sensor connected to the connector.

8. The load detection device according to claim 7, wherein
the control circuit executes a process for making a notification of the crossing position for which it has been determined that an abnormality is present.

9. The load detection device according to claim 5, wherein
the control circuit acquires a type of the load sensor inputted by a user, and based on a fact that the type of the load sensor inputted by the user and the type of the load sensor detected through application of a voltage to the terminals do not match each other, executes a process of making a notification of a mismatch.
